(19) United States
(12) Patent Application Publication
(10) Pub. No.: US 2024/0022984 A1
(43) Pub. Date: Jan. 18, 2024

(54) SATELLITE DATA PROVISIONING IN A NON-TERRESTRIAL NETWORK

(71) Applicant: Telefonaktiebolaget LM Ericsson (PUBL), Stockholm (SE)

(72) Inventors: Magnus Åström, LUND (SE); Talha Khan, SANTA CLARA, CA (US); Xingqin Lin, SAN JOSÈ, CA (US); Helka-Liina Määttänen, Espoo (FI)

(21) Appl. No.: 18/249,654

(22) PCT Filed: Oct. 20, 2021
(86) PCT No.: PCT/SE2021/051041

§ 371 Date: Apr. 19, 2023

Related U.S. Application Data
(60) Provisional application No. 63/104,082, filed on Oct. 22, 2020.

(51) Int. Cl. H04W 36/08; H04B 7/185

(52) U.S. Cl. CPC H04W 36/083; H04B 7/18519

(57) ABSTRACT

A method by a wireless device includes receiving, from a network node, data associated with the airborne or spaceborne system. The data includes satellite ephemeris data and a validity duration for the ephemeris data.

### PRIORITY

This nonprovisional application is a U.S. National Stage Filing under 35 U.S.C. § 371 of International Patent Application Serial No. PCT/SE2021/051041 filed Oct. 20, 2021 and entitled “SATELLITE DATA PROVISIONING IN A NON-TERRESTRIAL NETWORK” which claims priority to U.S. Provisional Patent Application No. 63/104,082 filed Oct. 22, 2020, both of which are hereby incorporated by reference in their entirety.

### TECHNICAL FIELD

The present disclosure relates, in general, to wireless communications and, more particularly, systems and methods for satellite data provisioning in a Non-Terrestrial Network (NTN).

### BACKGROUND

In 3^{rd} Generation Partnership Project (3GPP) Release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since Release 13 Narrowband-Internet of Things (NB-IoT) and LTE-M are part of the LTE specifications and provide connectivity to massive machine type communications (mMTC) services.

In 3GPP Release 15, the first release of the 5G System (5GS) was specified. This is a new generation's radio access technology intended to serve use cases such as enhanced mobile broadband (eMBB), ultra-reliable and low latency communication (URLLC) and mMTC. 5G includes the New Radio (NR) access stratum interface and the 5G Core Network (5GC). The NR physical and higher layers are reusing parts of the LTE specification, and additional components are introduced when motivated by the new use cases.

In Release 15, 3GPP also started the work to prepare NR for operation in a Non-Terrestrial Network (NTN). The work was performed within the study item “NR to support Non-Terrestrial Networks” and resulted in TR 38.811 [Error! Reference source not found.]. In Release 16, the work to prepare NR for operation in an NTN network continued with the study item “Solutions for NR to support Non-Terrestrial Network”. In parallel, the interest to adapt LTE for operation in NTN is growing. As a consequence, 3GPP is working on support for NTN in both LTE and NR in Release 17.

### Satellite Communications

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite Access link that refers to the link between a satellite and a UE.

Depending on the orbit altitude, a satellite may be categorized as low earth orbit (LEO), medium earth orbit (MEO), or geostationary earth orbit (GEO) satellite:
LEO: Typical heights ranging from 250-1,500 km, with orbital periods ranging from 90-120 minutes.
MEO: Typical heights ranging from 5,000-25,000 km, with orbital periods ranging from 3-15 hours.
GEO: Height at about 35,786 km, with an orbital period of 24 hours.

The significant orbit height means that satellite systems are characterized by a path loss that is significantly higher than what is expected in terrestrial networks. To overcome the pathloss, it is often required that the access and feeder links are operated in line of sight conditions, and that the UE is equipped with an antenna offering high beam directivity.

A communication satellite typically generates several beams over a given area. The footprint of a beam is usually in an elliptic shape, which has been traditionally considered as a cell. The footprint of a beam is also often referred to as a spotbeam. The spotbeam may move over the earth surface with the satellite movement or may be earth fixed with some beam pointing mechanism used by the satellite to compensate for its motion. The size of a spotbeam depends on the system design, which may range from tens of kilometers to a few thousands of kilometers. FIG. 1 illustrates an example architecture of a satellite network with bent pipe transponders.

In comparison to the beams observed in a terrestrial network, the NTN beam may be very wide and cover an area outside of the area defined by the served cell. Beams covering adjacent cells will overlap and cause significant levels of intercell interference. To overcome the large levels of interference, a typical approach for an NTN is to configure different cells with different carrier frequencies and polarization modes.

Throughout this disclosure, the terms ‘beam’ and ‘cell’ are used interchangeably, unless explicitly noted otherwise. Though certain embodiments described herein are focused on NTN, the methods and techniques disclosed herein apply to any wireless network dominated by line of sight conditions.

### Ephemeris Data

According to 3GPP TR 38.821, ephemeris data should be provided to the UE such as, for example, to assist with pointing a directional antenna (or an antenna beam) towards the satellite and to calculate correct Timing Advance (TA) and Doppler shift. The contents of the ephemeris data and the procedures on how to provide and update such data have not yet been studied in detail.

A satellite orbit can be fully described using six parameters. Exactly which set of parameters is used can be decided by the system design; many different representations are possible. For example, a choice of parameters used often in astronomy is the set (a, ε, i, Ω, ω, t). Here, the semi-major axis a and the eccentricity ε describe the shape and size of the orbit ellipse; the inclination i, the right ascension of the ascending node Ω, and the argument of periapsis ω determine its position in space, and the epoch t determines a reference time (e.g. the time when the satellites moves through periapsis). FIG. 2 illustrates example orbital elements including these parameters.

A two-line element set (TLE) is a data format encoding a list of orbital elements of an Earth-orbiting object for a given point in time, the epoch. As an example of a different parametrization, TLEs use mean motion n and mean anomaly M instead of a and t.

A completely different set of parameters is the position and velocity vector (x, y, z, vₓ, v_{y}, v_{z}) of a satellite. These are sometimes called orbital state vectors. They can be derived from the orbital elements and vice versa since the information they contain is equivalent. All these formulations (and many others) are possible choices for the format of ephemeris data to be used in NTN.

It would be desirable if a wireless device such as a User Equipment (UE) could determine the position of a satellite with accuracy of at least a few meters [2]. However, several studies have shown that this might be hard to achieve when using the de-facto standard of TLEs. On the other hand, LEO satellites often have GNSS receivers and can determine their position with some meter level accuracy.

Another aspect discussed during the study item and captured in 3GPP TR 38.821 is the validity time of ephemeris data. Predictions of satellite positions in general degrade with increasing age of the ephemeris data used, due to atmospheric drag, maneuvering of the satellite, imperfections in the orbital models used, etc. Therefore, the publicly available TLE data are updated quite frequently, for example. The update frequency depends on the satellite and its orbit and ranges from weekly to multiple times a day for satellites on very low orbits which are exposed to strong atmospheric drag and need to perform correctional maneuvers often.

So, while it seems possible to provide the satellite position with the required accuracy, care needs to be taken to meet these requirements such as, for example, when choosing the ephemeris data format, or the orbital model to be used for the orbital propagation.

Ephemeris data consists of at least five parameters describing the shape and position in space of the satellite orbit. It also comes with a timestamp, which is the time when the other parameters describing the orbit ellipse were obtained. The position of the satellite at any given time in the nearer future can be predicted from this data using orbital mechanics. The accuracy of this prediction will, however, degrade as one projects further and further into the future. The validity time of a certain set of parameters depends on many factors like the type and altitude of the orbit, but also the desired accuracy, and ranges from the scale of a few days to a few years.

### SUMMARY

Certain aspects of the present disclosure and their embodiments may provide solutions to these or other challenges. For example, according to certain embodiments, methods and systems are disclosed to provide satellite ephemeris data in an NTN.

According to certain embodiments, a method by a wireless device includes receiving, from a network node, data associated with the airborne or spaceborne system. The data includes satellite ephemeris data and a validity duration for the ephemeris data.

According to certain embodiments, a wireless device is adapted to receive, from a network node, data associated with the airborne or spaceborne system. The data includes satellite ephemeris data and a validity duration for the ephemeris data.

According to certain embodiments, a method by a network node includes transmitting data associated with an airborne or spaceborne system to a wireless device. The data includes satellite ephemeris data and a validity duration for the ephemeris data.

According to certain embodiments, a network node is adapted transmit data associated with an airborne or spaceborne system to a wireless device. The data includes satellite ephemeris data and a validity duration for the ephemeris data.

Certain embodiments may provide one or more of the following technical advantages. For example, one technical advantage may be that certain embodiments enable the network node in an NTN to optimize the amount of satellite data that is provided to a device at a time. As another example, a technical advantage of certain embodiments may be that a wireless device may optimize its operations by only acquiring expired satellite data instead of all of it when only parts are expired. This leads to less network overhead and improved device power efficiency, both highly important properties. Conversely, without, such ephemeris data, it may be very expensive to perform cell search and neighbor cell measurements due to the large Doppler shift that is associated with non-geostationary satellites and the vast space that needs to be searched in order to detect a satellite.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example architecture of a satellite network with bent pipe transponders;

FIG. 2 illustrates example orbital elements including these parameters;

FIG. 3 illustrates an example wireless network, according to certain embodiments;

FIG. 4 illustrates an example network node, according to certain embodiments;

FIG. 5 illustrates an example method by a network node, according to certain embodiments;

FIG. 6 illustrates an example virtual apparatus, according to certain embodiments;

FIG. 7 illustrates another example method by a network node, according to certain embodiments;

FIG. 8 illustrates another example virtual apparatus, according to certain embodiments;

FIG. 9 illustrates another example method by a network node, according to certain embodiments;

FIG. 10 illustrates another example virtual apparatus, according to certain embodiments;

FIG. 11 illustrates an example of neighbor satellites and replacing satellites in a cell, according to certain embodiments;

FIG. 12 illustrates an example wireless device, according to certain embodiments;

FIG. 13 illustrates an example method by a wireless device, according to certain embodiments;

FIG. 14 illustrates another example virtual apparatus, according to certain embodiments;

FIG. 15 illustrates another example method by a wireless device, according to certain embodiments;

FIG. 16 illustrates another example virtual apparatus, according to certain embodiments;

FIG. 17 illustrates another example method by a wireless device, according to certain embodiments;

FIG. 18 illustrates another example virtual apparatus, according to certain embodiments;

FIG. 19 illustrate an example user equipment, according to certain embodiments;

FIG. 20 illustrates a virtualization environment in which functions implemented by some embodiments may be virtualized, according to certain embodiments;

FIG. 21 illustrates a telecommunication network connected via an intermediate network to a host computer, according to certain embodiments;

FIG. 22 illustrates a generalized block diagram of a host computer communicating via a base station with a user equipment over a partially wireless connection, according to certain embodiments;

FIG. 23 illustrates a method implemented in a communication system, according to one embodiment;

FIG. 24 illustrates another method implemented in a communication system, according to one embodiment;

FIG. 25 illustrates another method implemented in a communication system, according to one embodiment; and

FIG. 26 illustrates another method implemented in a communication system, according to one embodiment.

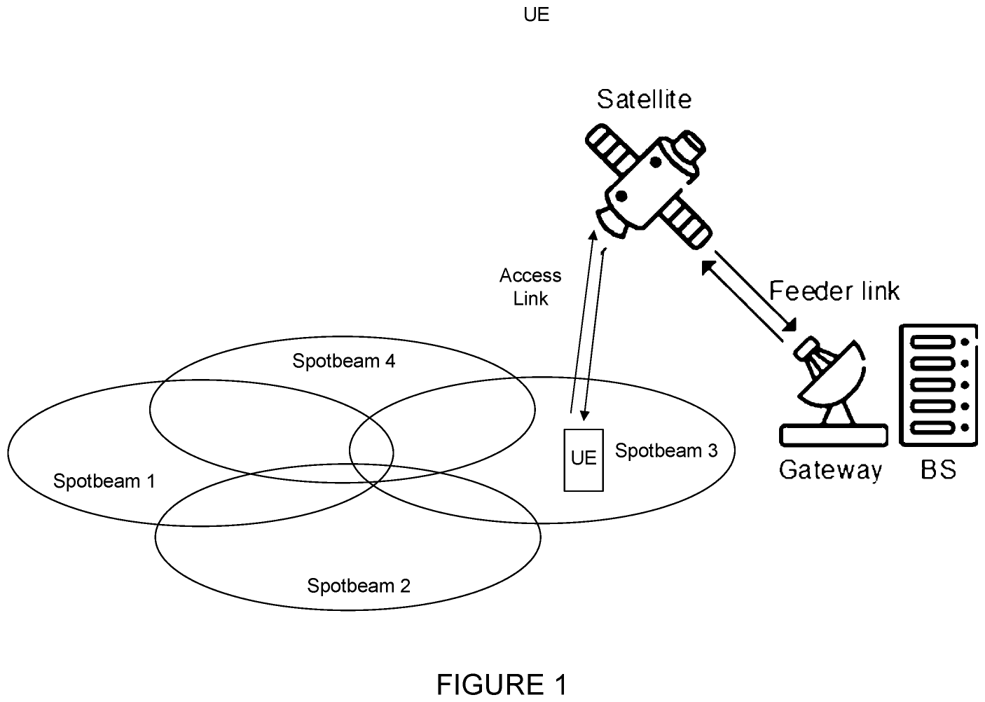

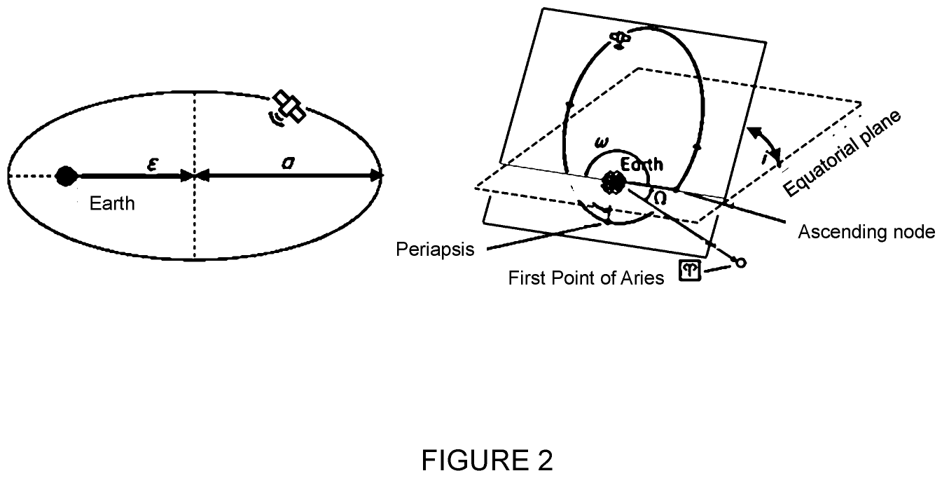

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, Master eNodeB (MeNB), a network node belonging to Master Cell Group (MCG) or Secondary Cell Group (SCG), base station (BS), multi-standard radio (MSR) radio node such as MSR BS, eNodeB (eNB), gNodeB (gNB), network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. Evolved Serving Mobile Location Center (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, Personal Digital Assistant (PDA), Tablet, mobile terminals, smart phone, laptop embedded equipped (LEE), laptop mounted equipment (LME), Unified Serial Bus (USB) dongles, UE category M1, UE category M2, Proximity Services UE (ProSe UE), Vehicle-to-Vehicle (V2V UE), Vehicle-to-Anything (V2X UE), etc.

Additionally, terminologies such as base station/gNB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

According to certain embodiments, methods and systems are disclosed to provide satellite ephemeris data in an NTN. Specifically, methods and systems are provided wherein a network node first determines a set of satellites for which ephemeris data is to be provided to devices in the cell. The network node further determines the ephemeris data of said satellites. Finally, the network node transmits the ephemeris data of the satellites in the determined satellite set. Alternatively, the network node may forward the ephemeris data to another network node that, in turn, transmits it.

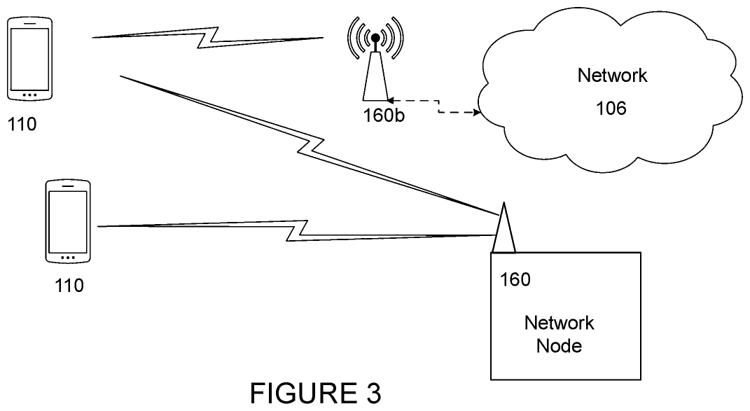

FIG. 3 illustrates a wireless network that includes satellite ephemeris data provisioning, in accordance with some embodiments. Although the subject matter described herein may be implemented in any appropriate type of system using any suitable components, the embodiments disclosed herein are described in relation to a wireless network, such as the example wireless network illustrated in FIG. 3. For simplicity, the wireless network of FIG. 3 only depicts network 106, network nodes 160 and 160b, and wireless devices 110. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

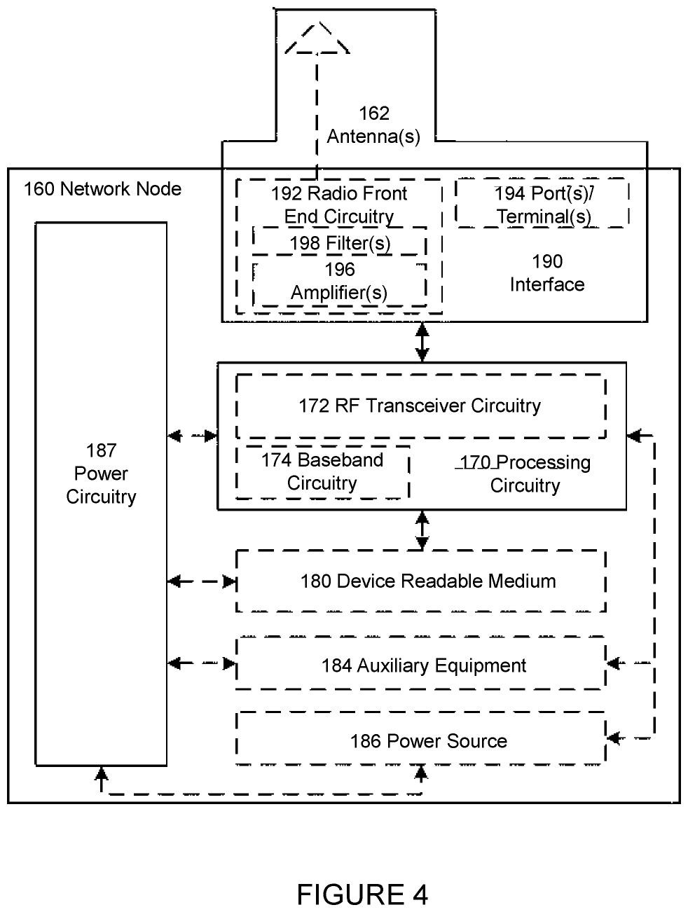

FIG. 4 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 160 includes processing circuitry 170, device readable medium 180, interface 190, auxiliary equipment 184, power source 186, power circuitry 187, and antenna 162. Although network node 160 illustrated in the example wireless network of FIG. 4 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 4 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

According to certain embodiments, a method by a network node is provided to efficiently provide airborne or spaceborne platform data to a wireless device that needs to perform an action. Examples of spaceborne platforms include low Earth orbiting (LEO) satellites, medium Earth orbiting (MEO) satellites, and geosynchronous Earth orbiting (GEO) satellites. Examples of airborne platforms include airplanes, balloons, and airships, which can collectively be referred to as High Altitude Platform Stations (HAPS). Though satellite is used as a concrete example to describe the methods herein, the techniques, systems, and methods are also applicable to HAPS.

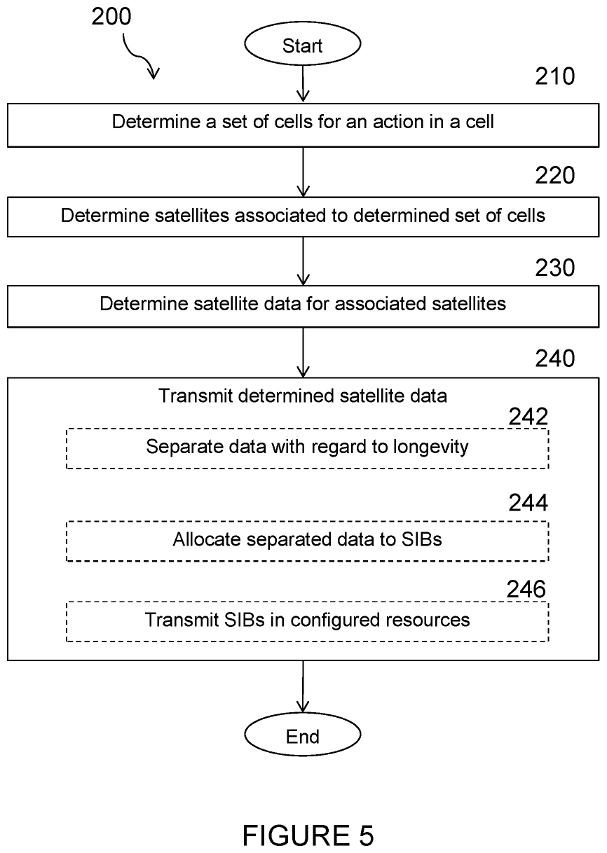

FIG. 5A illustrates a flowchart of an example method 200 by a network node 160, according to certain embodiments. The network provides satellite information to a wireless device such as a UE, for example.

At a step 210, the network node first determines a set of cells that are to be included in the action to be performed by the wireless device. An action, in this aspect, may be, e.g., a neighbor cell mobility measurement or a stationary replacement satellite measurement, i.e., a satellite that will replace the present satellite that is providing coverage in the serving or camping cell using an earth fixed beam. Other actions are not precluded.

At step 220, having determined the cells upon which the action is to be performed, the network node then determines the satellites that are associated with said cells. For neighbor cell measurements, it may be identified that two cell types exist: Cells for which the same satellite is associated to all neighbor cells and the serving cell, and cells for which at least one other satellite is associated to at least one neighbor cell.

Upon determining the satellites associated with respective cells, the satellite data is determined for the associated satellites, at step 230. Such satellite data may include, but is not limited to: Cell Identifier (Cell ID); Satellite Identifier (Satellite ID); Carrier information (e.g. frequency, bandwidth) and/or Bandwidth part (BWP) of cell; Satellite ephemeris data; Time interval of cell coverage; Validity duration for ephemeris data; Cell reference location; Koffset.

The Cell ID and Satellite ID are included to identify to which cell and satellite, respectively, the data relates. The carrier information and/or bandwidth part is included to indicate where in the spectrum the cell may be found since overlapping cells may be disadvantageous. Satellite ephemeris data is included to indicate the satellite trajectory and position, network orbits that are used in the NTN, etc. The time interval indicates during which time some of the data is valid. For example, a satellite will only cover a cell while it is visible in that cell after which it needs to be replaced with another satellite. Hence, the satellite data may comprise both current and future data.

At step 240, the determined satellite data is transmitted to the wireless device. In various particular embodiments, the transmission step may further be separated into substeps: in a first substep 242, satellite data may be separated such as, for example, with regard to data longevity. Separating with regard to longevity implies that data that the device will need to update frequently is separated from data that the device will need to update infrequently. Frequently updated data may consist of the Satellite ID serving the cells upon which the action is to be performed. For example, the satellite that is associated with a neighbor cell may change frequently and hence, the Satellite ID associated with that satellite will need frequent update. In another example, ephemeris data of a satellite may last for hours or more, implying it may need less frequent updates. In yet another example, satellite orbits or suborbits may only need infrequent updates due to, for example, the addition or removal of satellites to the network. Longevity may not be explicitly stated as a reason for separation, but it may be implicit such that data is separated with regard to which SIB it is located in with the implicit understanding that some SIBs need to be decoded more often than others.

Longevity of data, and thereby the need for updating it, may further depend on satellite altitude. For example, visibility of a typical LEO satellite passage may be less than 10 minutes (with earth-fixed beams) whereas a MEO satellite passage may be visible from earth for several hours and GEO satellites appears to be located at fixed locations in the sky making them always visible from the same location on earth.

In a second substep 244, data may be allocated to SIBs for transmission, in a particular embodiment. As stated earlier, data belonging to different SIBs may need to be decoded more or less often, which is why the transmission frequency of the SIBs may also differ such that the more frequently needed data is provided in more frequently transmitted SIBs. Finally, in a substep 246, the different SIBs are transmitted in their respective configured resources.

In a particular embodiment, the network node may indicate updates to the satellite data in an easily accessible signal or channel, e.g., SIB1, a DCI indicating a short message that signals the satellite data is updated. In that case, this update may indicate that any of the satellite information is new or that a subset of the satellite data is new. Such a subset of the satellite data may comprise unexpected changes, such as, for example, due to an unexpected event, changes that the device is not able to predict, changes that occur infrequently, or similar. In a related embodiment, the information may also indicate which kind of information is updated.

In a particular embodiment, steps 210-242 may be executed in a separate node from steps 244-246. In that case, the former steps may be executed in, e.g., a core network node and the latter steps may be executed in a Radio Access Network (RAN) node, e.g., a gNB, a satellite gateway node or in a regenerative satellite node.

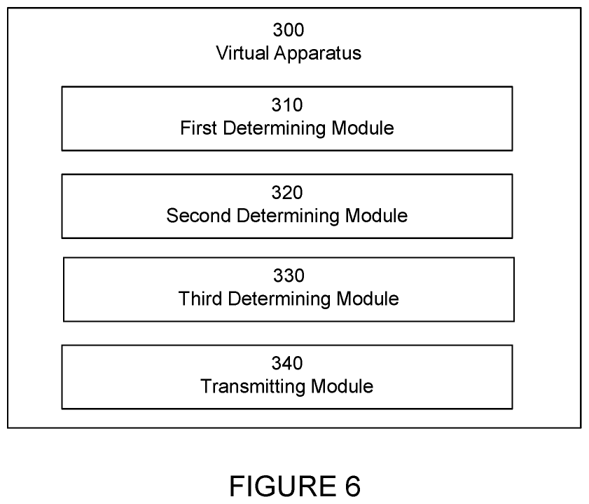

FIG. 6 illustrates a schematic block diagram of a virtual apparatus 300 in a wireless network (for example, the wireless network shown in FIG. 3). The apparatus may be implemented in a wireless device or network node (e.g., wireless device 110 or network node 160 shown in FIG. 3). Apparatus 300 is operable to carry out the example method described with reference to FIG. 5 and possibly any other processes or methods disclosed herein. It is also to be understood that the method of FIG. 5 is not necessarily carried out solely by apparatus 300. At least some operations of the method can be performed by one or more other entities.

Virtual Apparatus 300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first determining module 310, second determining module 320, third determining module 330, transmitting module 340, and any other suitable units of apparatus 300 to perform corresponding functions according one or more embodiments of the present disclosure.

According to certain embodiments, first determining module 310 may perform certain of the determining functions of the apparatus 300. For example, first determining module 310 may determine a set of cells that are to be included for the action to be performed by a wireless device.

According to certain embodiments, second determining module 320 may perform certain other of the determining functions of the apparatus 300. For example, second determining module 320 may determine the satellites that are associated with the cells upon which the action is to be performed.

According to certain embodiments, third determining module 330 may perform certain other of the determining functions of the apparatus 300. For example, third determining module 330 may determine the satellite data for the associated satellites.

According to certain embodiments, transmitting module 340 may perform certain of the transmitting functions of the apparatus 300. For example, transmitting module 340 may transmit the determined satellite data to the wireless device.

As used herein, the term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

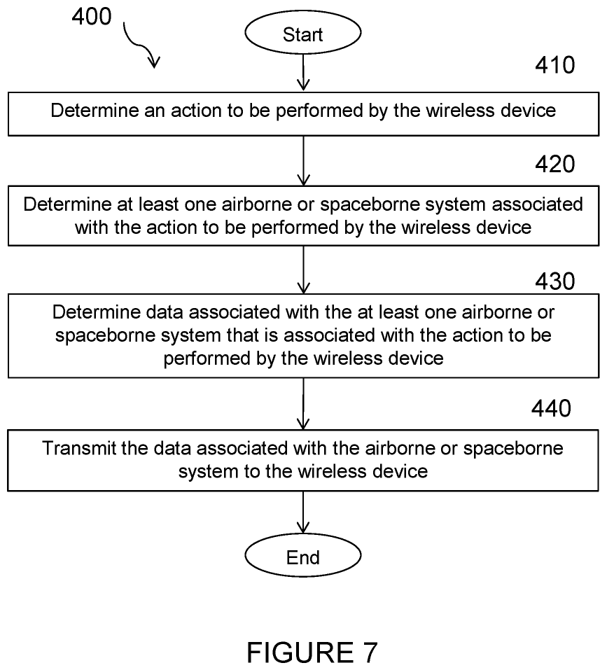

FIG. 7 depicts another method 400 by a network node 160, according to certain embodiments. At step 410, the network node 160 determines an action to be performed by the wireless device 110. At step 420, the network node 160 determines at least one an airborne or spaceborne system associated with the action be performed by the wireless device 110. At step 430, the network node 160 determines data associated with the at least one an airborne or spaceborne system that is associated with the action to be performed by the wireless device 110. At step 440, the network node 160 transmits the data associated with the airborne or spaceborne system to the wireless device 110.

In a particular embodiment, the network node 160 determines at least one cell associated with the action to be performed by the wireless device 110.

In a particular embodiment, the at least one cell comprises at least one cell that neighbors a serving cell in which the wireless device 110 is currently served.

In a further particular embodiment, the at least one cell that neighbors the serving cell comprises an edge cell, and the data further comprises data associated at least one additional neighboring cell.

In a further particular embodiment, the at least one cell that neighbors the serving cell comprises a corner cell, and the data further comprises data associated at least two additional neighboring cells.

In a further particular embodiment, the at least one cell comprises a serving cell in which the wireless device 110 is served, and the data comprises data associated with the at least one serving cell.

In a particular embodiment, the action to be performed by the wireless device 110 comprises at least one of: performing a Radio Resource Management (RRM) measurement for the at least one cell; replacing a RRM measurement for the at least one cell; performing a user equipment (UE) mobility handover to the at least one cell; and performing a service link handover to the at least one cell.

In a further particular embodiment, the action includes performing the service link handover and the data comprises ephemeris data associated with a satellite in a serving cell that will provide coverage in the serving cell at a future time.

In a further particular embodiment, the action includes performing the UE mobility handover and/or a RRM measurement, and the data includes ephemeris data associated with a satellite in a cell that neighbors a serving cell in which the wireless device 110 is currently served.

In a further particular embodiment, the network node 160 determines the at least one cell is associated with the airborne or spaceborne system.

In a particular embodiment, the method by the network node 160 further includes: determining that at least a portion of the data associated with the airborne or spaceborne system is expired or will expire; determining updated data for the portion of the data that is expired or will expire; and transmitting the updated data to the wireless device 110.

In a further particular embodiment, determining that the portion of the data is expired or will expire includes determining that a timer associated with the data has expired or will expire.

In a further particular embodiment, the updated data is transmitted in at least one SIB.

In a further particular embodiment, the method further includes transmitting, by the network node 160, a signal to the wireless device 110, and the signal indicates that the data has been updated.

In a further particular embodiment, the signal is DCI indicating that the data has been updated.

In a further particular embodiment, the signal comprises a short message code point.

In a particular embodiment, the signal comprises a SIB1.

In a particular embodiment, the data associated with the airborne or spaceborne system comprises at least one of: a cell identifier; a satellite identifier; carrier information and/or Bandwidth part (BWP) of the neighboring cell; satellite ephemeris data; time interval of cell coverage; cell reference location; and Koffset.

In a particular embodiment, the data associated with the airborne or spaceborne system comprises at least one of: semi-stationary data that changes according to a first periodicity; coarse data that changes according to a second periodicity; and fine data that changes according third periodicity. The first periodicity is greater than the second periodicity and the third periodicity, and the second periodicity is greater than the third periodicity.

In a further particular embodiment, transmitting the data comprises transmitting the semi-stationary data, the coarse data, and the fine data in separate transmissions.

In a further particular embodiment, the fine data comprises a satellite index.

In a further particular embodiment, the coarse data comprises at least one of: a satellite index, and short term ephemeris data.

In a further particular embodiment, the semi-stationary data comprises at least one of: an orbit index, and long term ephemeris data.

In a further particular embodiment, a transmission of the fine data comprises a reference a SIB containing the coarse data.

In a particular embodiment, the airborne or spaceborne system comprises at least one satellite. In a further particular embodiment, the at least one satellite comprises a satellite associated with a cell that neighbors a serving cell in which the wireless device 110 is served. In a further particular embodiment, the at least one satellite comprises a satellite associated with a serving cell, and the satellite provides future coverage of the serving cell for the wireless device 110.

In a particular embodiment the airborne or spaceborne system comprises a High Altitude Platform System (HAPS) or a HAPS as IMT Base Station (HIBS).

In a particular embodiment, the network node 160 separates the data associated with the airborne or spaceborne system into at least two portions of data. Each portion of data is associated with a measure of longevity, and each measure of longevity is a measure of how long each portion of data will be valid and/or require an update.

In a particular embodiment, transmitting the data comprises transmitting the data via SI.

In a further particular embodiment, prior to transmitting the SI, the network node transmits a signal to the wireless device. The signal indicates at least one transmission resource for receiving the SI by the wireless device 110. In a further particular embodiment, the at least one transmission resource comprises at least one a transmission time, a transmission frequency, and/or a periodicity.

In a further particular embodiment, the signal comprises a SIB1 or a downlink control information (DCI) message.

In a particular embodiment, transmitting the data includes periodically transmitting the data to the wireless device 110.

In a particular embodiment, prior to determining the at least one an airborne or spaceborne system associated with the action be performed by the wireless device 110, the network node 160 determines at least one coverage type for which the data is to be provided.

In a further particular embodiment, in the at least one coverage type comprises at least one of: a current neighboring cell coverage, a future serving cell coverage; and a future neighboring cell coverage.

In a further particular embodiment, each type of the at least one coverage type is associated with a SIB index, a SIB periodicity, and/or a ephemeris content.

In a further particular embodiment, each type of the at least one coverage type is associated with a particular one of a plurality of satellites.

In a particular embodiment, the at least one coverage type is associated with a satellite index.

In a particular embodiment, the at least one coverage type is associated with an ephemeris validity duration.

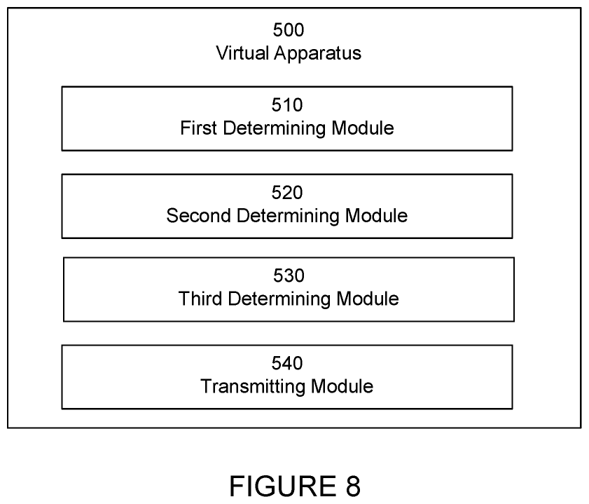

FIG. 8 illustrates a schematic block diagram of a virtual apparatus 500 in a wireless network (for example, the wireless network shown in FIG. 3). The apparatus may be implemented in a wireless device or network node (e.g., wireless device 110 or network node 160 shown in FIG. 3). Apparatus 500 is operable to carry out the example method described with reference to FIG. 7 and possibly any other processes or methods disclosed herein. It is also to be understood that the method of FIG. 7 is not necessarily carried out solely by apparatus 500. At least some operations of the method can be performed by one or more other entities.

Virtual Apparatus 500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first determining module 510, second determining module 520, third determining module 530, transmitting module 540, and any other suitable units of apparatus 500 to perform corresponding functions according one or more embodiments of the present disclosure.

According to certain embodiments, first determining module 510 may perform certain of the determining functions of the apparatus 500. For example, first determining module 510 may determine an action to be performed by the wireless device.

According to certain embodiments, second determining module 520 may perform certain of the determining functions of the apparatus 500. For example, second determining module 520 may determine at least one an airborne or spaceborne system associated with the action be performed by the wireless device.

According to certain embodiments, third determining module 530 may perform certain of the determining functions of the apparatus 500. For example, third determining module 530 may determine data associated with the at least one an airborne or spaceborne system that is associated with the action to be performed by the wireless device.

According to certain embodiments, transmitting module 540 may perform certain of the transmitting functions of the apparatus 500. For example, transmitting module 540 may transmit the data associated with the airborne or spaceborne system to the wireless device.

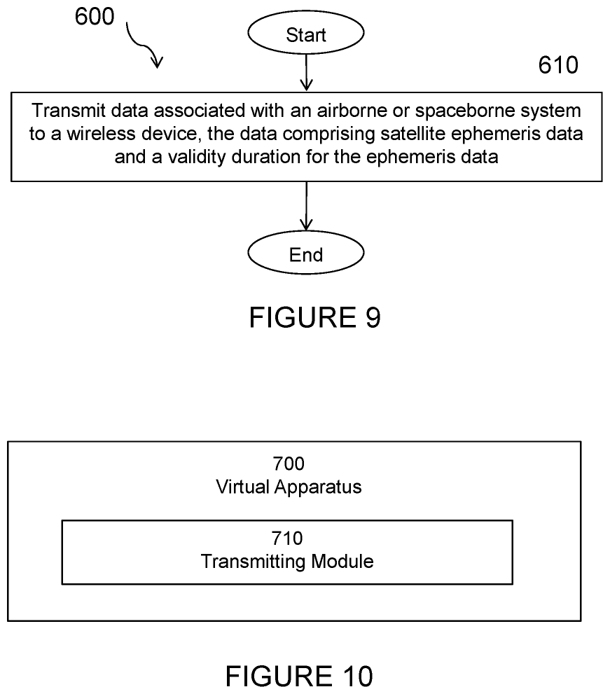

FIG. 9 depicts another method 600 by a network node 160, according to certain embodiments. At step 610, the network node 160 transmits data associated with an airborne or spaceborne system to a wireless device 110. The data includes satellite ephemeris data and a validity duration for the ephemeris data.

In a particular embodiment, the network node 160 determines an action to be performed by the wireless device 110 based on the data associated with the airborne or spaceborne system.

In a further particular embodiment, the action is associated with at least one cell.

In a further particular embodiment, the at least one cell comprises a serving cell in which the wireless device is currently served.

In a further particular embodiment, the at least one cell comprises at least one cell that neighbors the serving cell in which the wireless device is currently served.

In a further particular embodiment, the airborne or spaceborne system comprises at least one satellite associated with the serving cell or the at least one cell that neighbors the serving cell.

In a further particular embodiment, the action comprises a service link handover and the ephemeris data is associated with a satellite, the satellite providing coverage in a serving cell at a future time.

In a further particular embodiment, the action comprises a UE mobility handover and/or a RRM measurement and the ephemeris data is associated with a satellite in a cell that neighbors a serving cell in which the wireless device is currently served.

In a particular embodiment, the network node 160 determines that at least a portion of the data associated with the airborne or spaceborne system is expired or will expire. The network node 160 also determines updated data for the portion of the data that is expired or will expire and transmits, to the wireless device 110, information indicating that the data has been updated.

In a particular embodiment, when determining that the portion of the data is expired or will expire, the network node 160 determines that a timer associated with the data has expired or will expire.

In a further particular embodiment, the information transmitted to the wireless device 110 includes the updated data.

In a particular embodiment, the information transmitted to the wireless device 110 comprises system information (SI), downlink control information (DCI), or a short message code point.

In a particular embodiment, the data associated with the airborne or spaceborne system comprises at least one of: a cell identifier; a satellite identifier; carrier information and/or BWP of a neighboring cell; time interval of cell coverage; cell reference location; and Koffset.

In a particular embodiment, the data associated with the airborne or spaceborne system comprises at least one of semi-stationary data that changes according to a first periodicity, coarse data that changes according to a second periodicity, and fine data that changes according third periodicity. The first periodicity is greater than the second periodicity and the third periodicity, and the second periodicity is greater than the third periodicity.

In a further particular embodiment, the coarse data comprises at least one of: a satellite index, and short term ephemeris data, and the semi-stationary data comprises at least one of: an orbit index, and long term ephemeris data.

In a particular embodiment, when transmitting the data, the network node 160 transmits the data via SI.

In a particular embodiment, prior to transmitting the SI, the network node 160 transmits a signal to the wireless device 110, and the signal indicates at least one transmission resource for receiving the SI by the wireless device. The at least one transmission resource includes at least one a transmission time, a transmission frequency, and/or a periodicity.

In a further particular embodiment, prior to transmitting the data to the wireless device 110, the network node 160 determines at least one coverage time interval for which the data is to be provided.

In a further particular embodiment, the at least one coverage time interval comprises at least one of: a current neighboring cell coverage time interval, a future serving cell coverage time interval; and a future neighboring cell coverage time interval.

In a further particular embodiment, the at least one coverage time interval is associated with a SIB index, a SIB periodicity, a ephemeris content, and/or a satellite index.

FIG. 10 illustrates a schematic block diagram of a virtual apparatus 700 in a wireless network (for example, the wireless network shown in FIG. 3). The apparatus may be implemented in a wireless device or network node (e.g., wireless device 110 or network node 160 shown in FIG. 3). Apparatus 700 is operable to carry out the example method described with reference to FIG. 9 and possibly any other processes or methods disclosed herein. It is also to be understood that the method of FIG. 9 is not necessarily carried out solely by apparatus 700. At least some operations of the method can be performed by one or more other entities.

Virtual Apparatus 700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 710, and any other suitable units of apparatus 700 to perform corresponding functions according one or more embodiments of the present disclosure.

According to certain embodiments, transmitting module 710 may perform certain of the transmitting functions of the apparatus 700. For example, transmitting module 710 may transmit data associated with an airborne or spaceborne system to a wireless device 110. The data includes satellite ephemeris data and a validity duration for the ephemeris data.

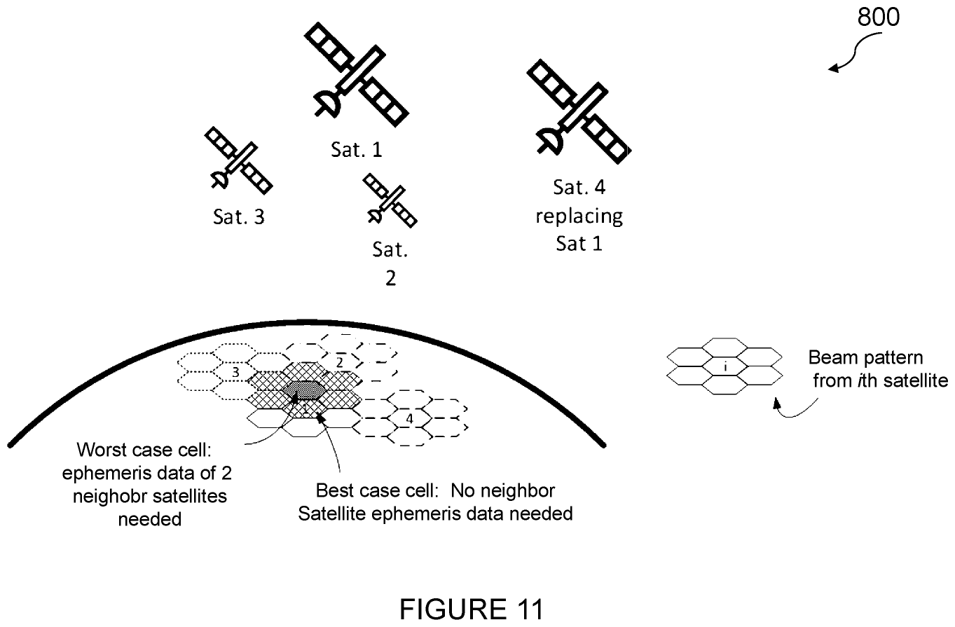

It may further be recognized that different cells may need different number of neighbor satellite information. FIG. 11 illustrates an example 800 of neighbor satellites and replacing satellites in a cell, according to certain embodiments. In the example of FIG. 11, each satellite projects seven beams or cells on an are on the ground. The center cell indicates the satellite index. Here, it is evident that the center cell may do entirely without any neighbor satellite data whereas an edge cell, i.e., a cell only neighboring cells from one additional satellite may require satellite data from one additional satellite. A corner cell is a cell neighboring cells from two additional satellites and may require satellite data from a corresponding number of satellites. Although in reality, cell borders may not be as perfect as in the illustration, it may still be assumed that different cells will have different needs for neighboring satellite data.

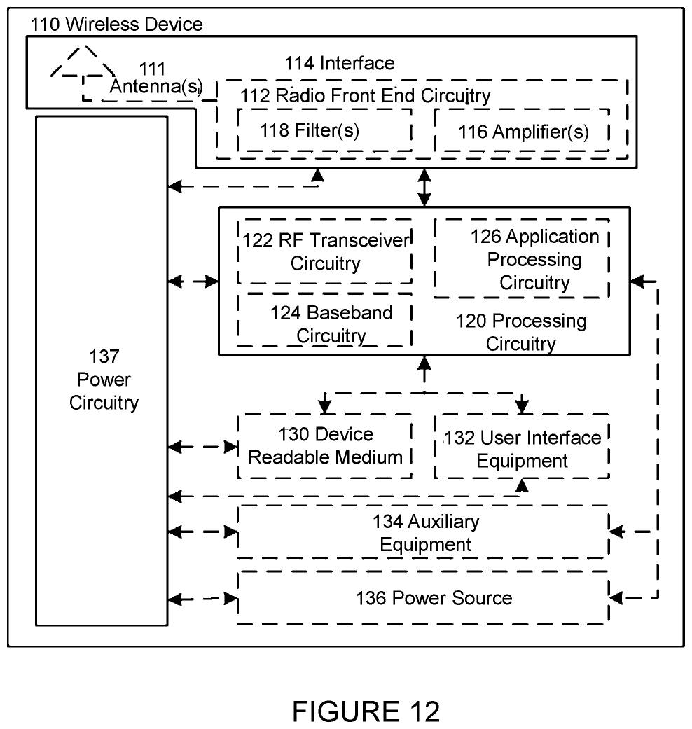

FIG. 12 illustrates an example wireless device 110, according to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. Wireless device 110 may include multiple sets of one or more of the illustrated components for different wireless technologies supported by wireless device 110, such as, for example, GSM, WCDMA, LTE, NR, WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

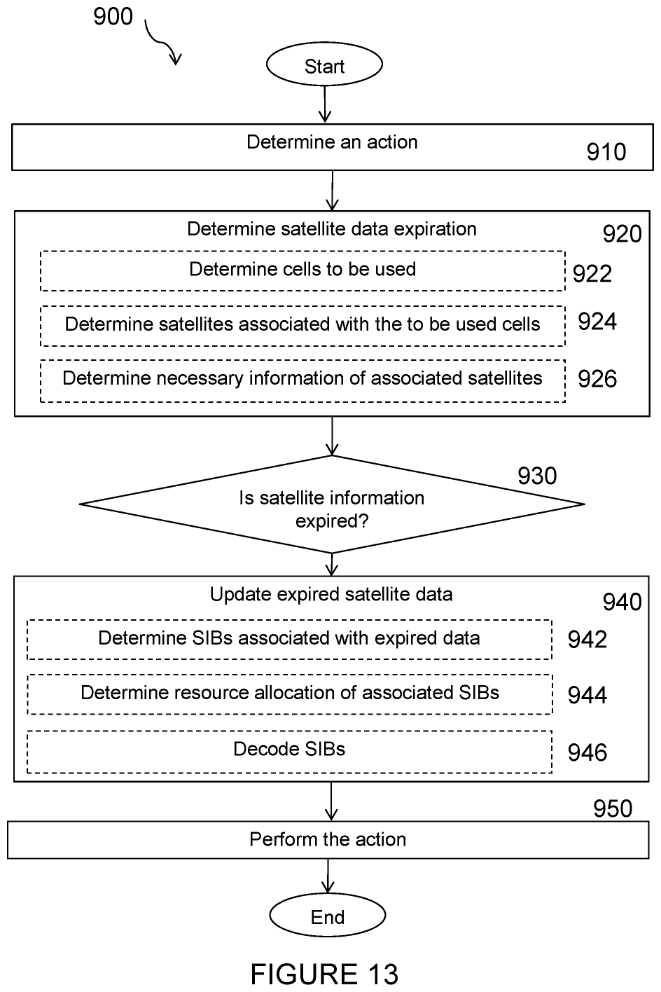

FIG. 13 illustrates an example method 900 by a wireless device 110, according to certain embodiments. The method illustrates a how a wireless device 110 decodes satellite data about a neighboring satellite in order for the wireless device 110 to perform an action related to the neighboring satellite.

At step 910, the wireless device 110 determines an action to perform on a neighboring cell associated to a neighboring satellite. For example, the action may include performing a neighbor cell measurement or replacing a satellite measurement or performing a handover. In a particular embodiment, the neighbor cell measurement may include a RSRP or other cell quality measurement.

In a second step 920, the wireless device 110 determines an expiration for the satellite data that is related to the determined action on the neighboring or replaced cell. In a particular embodiment, a first substep 922 of step 920, may include determining, by the wireless device 110, what cells to be used in the action. In a second substep 924, the satellites that are related to the determined cells may be identified, in a particular embodiment. Finally, in a third substep 926, the necessary information of the associated satellites may be determined, in a particular embodiment. Similar to the methods and techniques described above, in a particular embodiment, the satellite data may comprise at least one of: Cell ID; Satellite ID; carrier information (e.g. frequency, bandwidth) and/or Bandwidth part (BWP) of cell; satellite ephemeris data; time interval of cell coverage; cell reference location; Koffset; etc.

Following determining satellite data to be used for the action, the wireless device 110 determines if the satellite data is expired at step 930. This may be done by data being associated with a timer and the timer is expired.

Optionally, in case the satellite information is determined to be expired at step 930, the wireless device 110 may update the expired information, at step 940. In a particular embodiment, step 940 may also be divided into substeps such that in a first substep 942, the wireless device 110 determines which SIB is associated with the expired data, and in a second substep 944, the wireless device 110 determines the resource allocation of said SIB and in a final substep 946 the wireless device 110 decodes the SIB. In case satellite data is not expired, or subsequent to acquiring new satellite data, the wireless device 110 starts to perform the determined action at step 950.

In a particular embodiment, the wireless device 110 estimates when the action will be finished including updating the satellite data which includes any satellite data expiring before the end of the action. Such an estimate may be based on SIB transmission instants, measurement gaps associated with the action or other information that is known to the device.

In a particular embodiment, prior to updating satellite data, the wireless device 110 may decode an easily accessible signal or channel, e.g., SIB1, a DCI indicating a short message that is used to signal if the satellite data is updated, in order to determine if satellite data needs updating for reasons other than the already known time intervals. This may also include decoding what kind of satellite data that needs updating.

What is described above for satellites is equally valid for other airborne or spaceborne platforms, e.g., High Altitude Platform System (HAPS) or HAPS as IMT Base stations (HIBS).

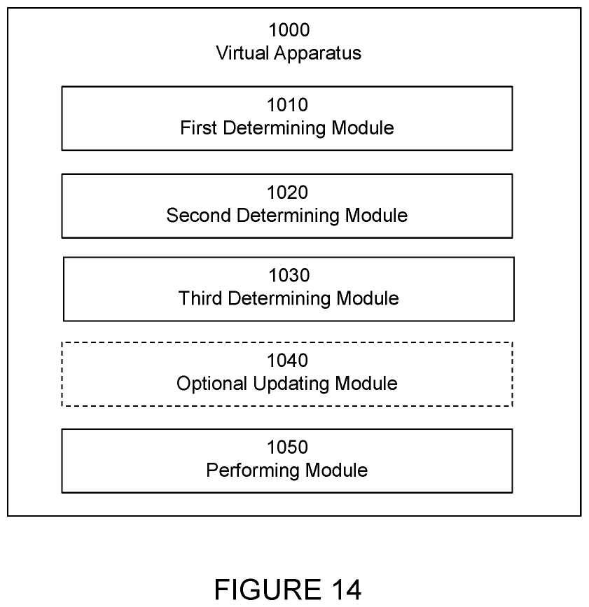

FIG. 14 illustrates a schematic block diagram of a virtual apparatus 1000 in a wireless network (for example, the wireless network shown in FIG. 3). The apparatus may be implemented in a wireless device or network node (e.g., wireless device 110 or network node 160 shown in FIG. 3). Apparatus 1000 is operable to carry out the example method described with reference to FIG. 13 and possibly any other processes or methods disclosed herein. It is also to be understood that the method of FIG. 13 is not necessarily carried out solely by apparatus 1000. At least some operations of the method can be performed by one or more other entities.

Virtual Apparatus 1000 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first determining module 1010, second determining module 1020, third determining module 1030, optional updating module 1040, performing module 1050, and any other suitable units of apparatus 1000 to perform corresponding functions according one or more embodiments of the present disclosure.

According to certain embodiments, first determining module 1010 may perform certain of the determining functions of the apparatus 1000. For example, first determining module 1010 may determine an action to perform on a neighboring cell associated to a neighboring satellite.

According to certain embodiments, second determining module 1020 may perform certain other of the determining functions of the apparatus 1000. For example, second determining module 1020 may determine an expiration associated with the satellite data for the satellites associated with the neighboring cells that are associated with the action to be performed.

According to certain embodiments, third determining module 1030 may perform certain other of the determining functions of the apparatus 1000. For example, third determining module 1030 may determine if the satellite data for the satellites associated with the neighboring cells that are associated with the action to be performed is expired.

According to certain embodiments, an optional updating module 1040 may perform certain of the updating functions of the apparatus 1000. For example, optional updating module 1040 may update the expired satellite data for the satellites associated with the neighboring cells that are associated with the action to be performed.

According to certain embodiments, performing module 1050 may perform certain of the performing functions of the apparatus 1000. For example, performing module 1050 may perform the action on the neighboring cell associated to the neighboring satellite.

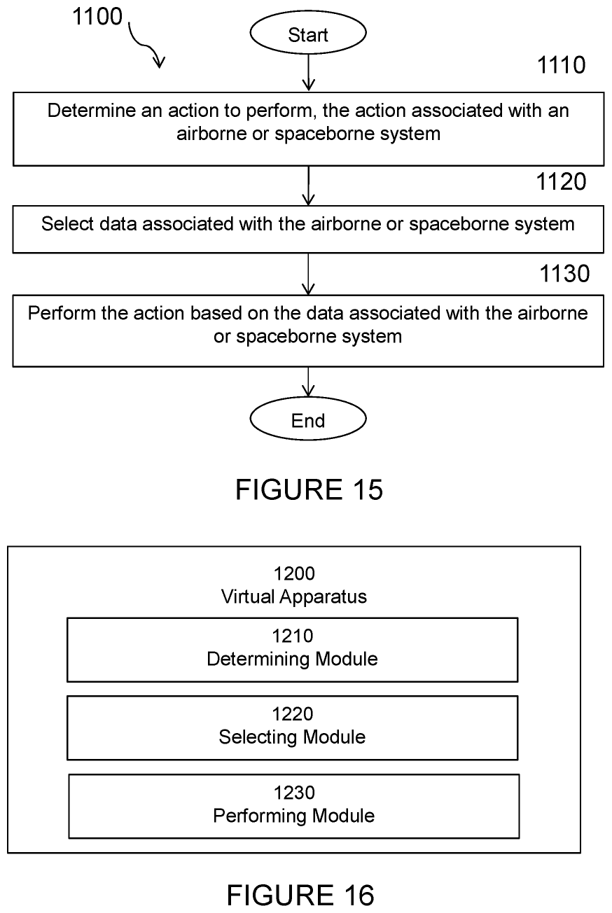

FIG. 15 depicts another method 1100 by a wireless device 110, according to certain embodiments. At step 1110, the wireless device 110 determines an action to perform, the action associated with an airborne or spaceborne system. At step 1120, the wireless device 110 selects data associated with the airborne or spaceborne system. At step 1130, the wireless device 110 performs the action based on the data associated with the airborne or spaceborne system.

In a particular embodiment, the wireless device 110 determines the airborne or spaceborne system that is associated with the action.

In a particular embodiment, the action comprises an action associated with at least one cell. In a further particular embodiment, the at least one cell comprises at least one cell that neighbors a serving cell in which the wireless device 110 is currently served. In a further particular embodiment, the at least one cell that neighbors the serving cell comprises an edge cell, and the data further comprises data associated at least one additional neighboring cell. In another particular embodiment, the at least one cell that neighbors the serving cell comprises a corner cell, and the data further comprises data associated at least two additional neighboring cells.

In a further particular embodiment, the at least one cell comprises at least one serving cell in which the wireless device 110 is served, and the data comprises data associated with the at least one serving cell.

In a particular embodiment, the action may include at least one of: performing a Radio Resource Management (RRM) measurement for the at least one cell; replacing a RRM measurement for the at least one cell; performing a user equipment (UE) mobility handover to the at least one cell; and performing a service link handover to the at least one cell.

In a further particular embodiment, the action comprises a service link handover and the data comprises ephemeris data associated with a satellite in a serving cell, the satellite providing coverage in the serving cell at a future time.

In a further particular embodiment, the action comprises the UE mobility handover and/or a RRM measurement and the data comprises ephemeris data associated with a satellite in a cell that neighbors a serving cell in which the wireless device is currently served.

In a particular embodiment, the wireless device 110 determines the at least one cell to be used in the action associated with the airborne or spaceborne system.

In a particular embodiment, the wireless device 110 determines that the data associated with the airborne or spaceborne system is valid. In a further particular embodiment, the wireless device 110 receives SI from the network node and determines that the data is valid based on the SI.

In a further particular embodiment, determining that the data associated with the airborne or spaceborne system is valid comprises: determining that at least a portion of the data associated with the airborne or spaceborne system is expired and updating the portion of the data that is expired.

In a further particular embodiment, determining that the portion of the data is expired includes determining that a timer associated with the data has expired.

In a further particular embodiment updating the portion of the data may include determining at least one system information block (SIB) associated with the data, determining a resource allocation associated with the SIB, receiving the SIB associated with the data, and decoding the SIB associated with the data.

In a further particular embodiment, determining that the data associated with the airborne or spaceborne system is valid may include: determining when the action will be complete; determining that at least a portion of the data associated with the action will expire before the action is complete; and updating the portion of the data that will expire before the action is complete.

In a further particular embodiment, determining that the data associated with the airborne or spaceborne system is valid may include decoding a signal from a network node 160 and determining, based on the signal from the network node 160, that the data associated with the airborne or spaceborne system is valid. In a further particular embodiment, the signal comprises SI. In another embodiment, the signal may include a SIB1. In still another embodiment, the signal may include DCI. In yet another embodiment, the signal may include a short message code point.

In a further particular embodiment, determining that the data associated with the action is valid may include: decoding a signal from a network node 160; determining, based on the signal from the network node 160, that the data associated with the airborne or spaceborne system needs to be updated; and updating the data associated with the airborne or spaceborne system.

In a further particular embodiment, determining that the data associated with the airborne or spaceborne system is valid may include determining that a timer associated with the data has not expired.

In a particular embodiment, the data associated with the airborne or spaceborne system comprises at least one of: a cell identifier; a satellite identifier; carrier information and/or Bandwidth part (BWP) of the neighboring cell; satellite ephemeris data; time interval of cell coverage; cell reference location; and Koffset.

In a particular embodiment, the data associated with the airborne or spaceborne system comprises at least one of semi-stationary data that changes according to a first periodicity, coarse data that changes according to a second periodicity, and fine data that changes according third periodicity. The first periodicity is greater than the second periodicity and the third periodicity, and the second periodicity is greater than the third periodicity.

In a further particular embodiment, the semi-stationary data, the coarse data, and the fine data are received in separate transmissions.

In a further particular embodiment, the fine data comprises a satellite index.

In a further particular embodiment, the coarse data comprises at least one of: a satellite index, and short term ephemeris data.

In a further particular embodiment, the semi-stationary data comprises at least one of: an orbit index, and long term ephemeris data.

In a further particular embodiment, a transmission of the fine data comprises a reference a SIB containing the coarse data.

In a particular embodiment, the wireless device may receive the data associated with the airborne or spaceborne system from the network node. In a further particular embodiment, the data comprises ephemeris data received as SI.

In another particular embodiment, prior to receiving the SI, the wireless device may receive a signal from the network node, the signal indicating at least one transmission resource for receiving the SI.

In a further particular embodiment, the signal comprises a SIB1 or a DCI message.

In a further particular embodiment, the at least one transmission resource comprises at least one a transmission time, a transmission frequency, and/or a periodicity.

In a particular embodiment, the data is periodically received.

In a particular embodiment, the airborne or spaceborne system comprises at least one satellite.

In a particular embodiment, the at least one satellite comprises a satellite associated with a cell that neighbors a serving cell in which the wireless device is served.

In a particular embodiment, the at least one satellite comprises a satellite associated with a serving cell, the satellite providing future coverage of the serving cell for the wireless device.

In a particular embodiment, the airborne or spaceborne system comprises a High Altitude Platform System (HAPS) or a HAPS as IMT Base Station (HIBS).

In a particular embodiment, the data associated with the airborne or spaceborne system comprises at least two portions of data, and each portion of data is associated with a measure of longevity. Each measure of longevity is a measure of how long each portion of data will be valid and/or require an update.

In a particular embodiment, the data is associated with at least one coverage type.

In a particular embodiment, the at least one coverage type comprises at least one of: a current neighboring cell coverage, a future serving cell coverage; and a future neighboring cell coverage.

In a further particular embodiment, each type of the at least one coverage type is associated with a SIB index, a SIB periodicity, and/or a ephemeris content.

In a further particular embodiment, each type of the at least one coverage type is associated with a particular one of a plurality of satellites.

In a further particular embodiment, the at least one coverage type is associated with a satellite index.

In a further particular embodiment, the at least one coverage type is associated with an ephemeris validity duration.

FIG. 16 illustrates a schematic block diagram of a virtual apparatus 1200 in a wireless network (for example, the wireless network shown in FIG. 3). The apparatus may be implemented in a wireless device or network node (e.g., wireless device 110 or network node 160 shown in FIG. 3). Apparatus 1200 is operable to carry out the example method described with reference to FIG. 15 and possibly any other processes or methods disclosed herein. It is also to be understood that the method of FIG. 15 is not necessarily carried out solely by apparatus 1200. At least some operations of the method can be performed by one or more other entities.

Virtual Apparatus 1200 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining module 1210, selecting module 1220, performing module 1230, and any other suitable modules and/or units of apparatus 1200 to perform corresponding functions according one or more embodiments of the present disclosure.

According to certain embodiments, determining module 1210 may perform certain of the determining functions of the apparatus 1200. For example, determining module 1210 may determine an action to perform, the action associated with an airborne or spaceborne system.

According to certain embodiments, selecting module 1220 may perform certain of the selecting functions of the apparatus 1200. For example, selecting module 1220 may select data associated with the airborne or spaceborne system.

According to certain embodiments, performing module 1230 may perform certain of the performing functions of the apparatus 1200. For example, performing module 1230 may perform the action based on the data associated with the airborne or spaceborne system.

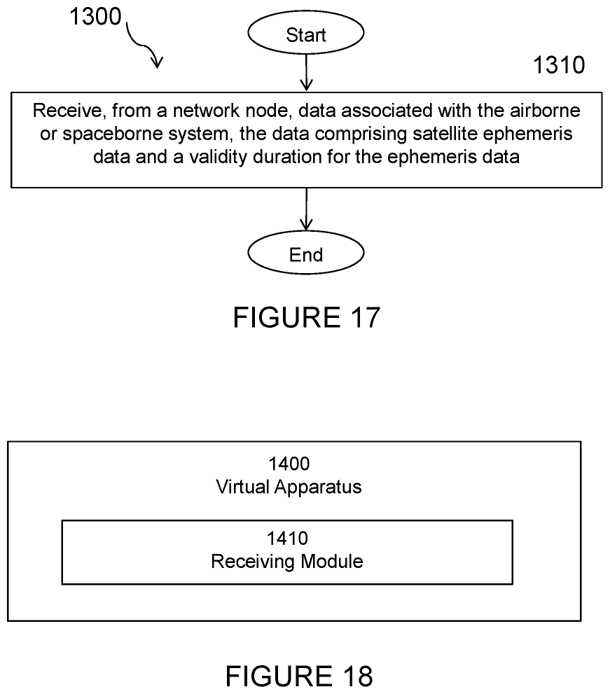

FIG. 17 depicts another method 1300 by a wireless device 110, according to certain embodiments. At step 1310, the wireless device 110 receives, from a network node 160, data associated with the airborne or spaceborne system. The data comprising satellite ephemeris data and a validity duration for the ephemeris data.

In a particular embodiment, the wireless device 110 performs an action based on the data associated with the airborne or spaceborne system.

In a further particular embodiment, the action associated with at least one cell.

In a particular embodiment, the wireless device 110 determines when the action will be complete and determines that at least a portion of the data will expire before the action is complete. The wireless device 110 updates the portion of the data that will expire before the action is complete.

In a further particular embodiment, the at least one cell comprises a serving cell in which the wireless device is currently served.

In a further particular embodiment, the at least one cell comprises at least one cell that neighbors the serving cell in which the wireless device is currently served.

In a further particular embodiment, when performing the at least one action, the wireless device 110 performs a measurement associated with the at least one cell that neighbors the serving cell before coverage in the serving cell ceases.

In a further particular embodiment, the airborne or spaceborne system comprises at least one satellite associated with the serving cell or the at least one cell that neighbors the serving cell.

In a further particular embodiment, the action comprises a service link handover and the ephemeris data is associated with a satellite providing coverage in the serving cell at a future time.

In a further particular embodiment, the action comprises a UE mobility handover and/or a RRM measurement and the ephemeris data is associated with a satellite in a cell that neighbors the serving cell in which the wireless device is currently served.

In a particular embodiment, the wireless device 110 determines whether the data associated with the airborne or spaceborne system is valid based on information received from the network node or based on whether a timer associated with the data has expired.

In a further particular embodiment, the information received from the network node comprises SI, DCI, or short message code point.

In a particular embodiment, upon determining that at least a portion of the data associated with the airborne or spaceborne system is expired or is about to expire, the wireless device 110 updates the portion of the data that is expired or is about to expire.

In a particular embodiment, the data associated with the airborne or spaceborne system further comprises at least one of: a cell identifier; a satellite identifier; carrier information and/or BWP of a neighboring cell; time interval of cell coverage; cell reference location; and Koffset. As used herein, the time interval of cell coverage includes a time the satellite begin providing coverage to an area until a time when the satellite will stop providing coverage to the area.

In a particular embodiment, the data associated with the airborne or spaceborne system comprises at least one of semi-stationary data that changes according to a first periodicity, coarse data that changes according to a second periodicity, and fine data that changes according to a third periodicity, and wherein:

the first periodicity is greater than the second periodicity and the third periodicity, and the second periodicity is greater than the third periodicity.

In a further particular embodiment, the coarse data comprises at least one of a satellite index and short term ephemeris data, and the semi-stationary data comprises at least one of an orbit index and long term ephemeris data.

In a particular embodiment, the data is associated with at least one coverage time interval. The at least one coverage time interval comprises at least one of: a current neighboring cell coverage time interval, a future serving cell coverage time interval; and a future neighboring cell coverage time interval.

In a particular embodiment, the at least one coverage time interval is associated with a SIB index, a SIB periodicity, a ephemeris content, and/or a satellite index.

FIG. 18 illustrates a schematic block diagram of a virtual apparatus 1400 in a wireless network (for example, the wireless network shown in FIG. 3). The apparatus may be implemented in a wireless device or network node (e.g., wireless device 110 or network node 160 shown in FIG. 3). Apparatus 1400 is operable to carry out the example method described with reference to FIG. 17 and possibly any other processes or methods disclosed herein. It is also to be understood that the method of FIG. 17 is not necessarily carried out solely by apparatus 1400. At least some operations of the method can be performed by one or more other entities.

Virtual Apparatus 1400 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1410 and any other suitable modules and/or units of apparatus 1400 to perform corresponding functions according one or more embodiments of the present disclosure.

According to certain embodiments, receiving module 1410 may perform certain of the receiving functions of the apparatus 1400. For example, receiving module 1410 may receive, from a network node 160, data associated with the airborne or spaceborne system. The data comprising satellite ephemeris data and a validity duration for the ephemeris data.

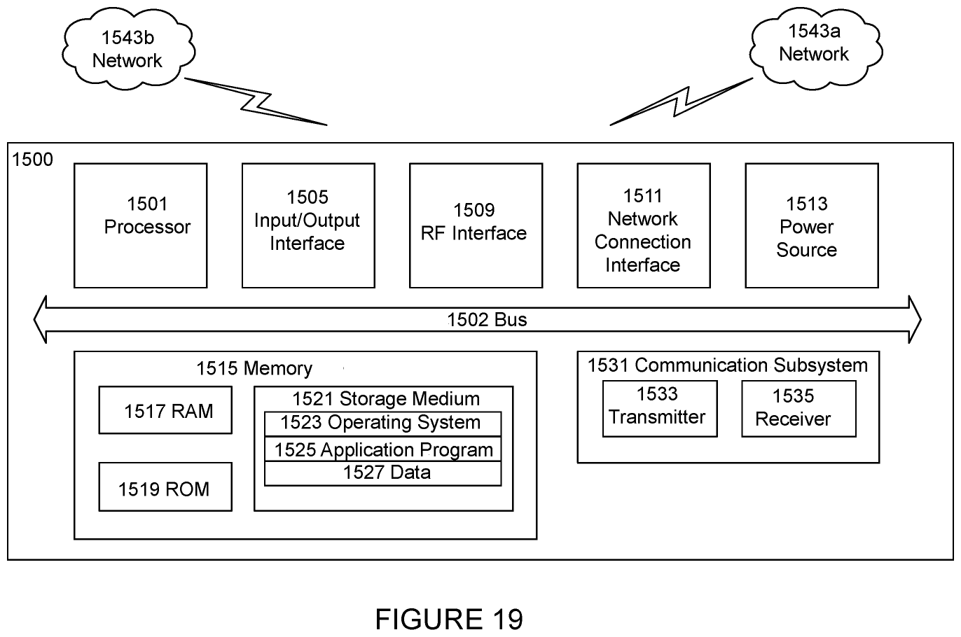

FIG. 19 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1500 may be any UE identified by the 3^{rd} Generation Partnership Project (3GPP), including a NB-IoT UE, a machine type communication (MTC) UE, and/or an enhanced MTC (eMTC) UE. UE 1500, as illustrated in FIG. 19, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 19 is a UE, the components discussed herein are equally applicable to a wireless device, and vice-versa.

In FIG. 19, UE 1500 includes processing circuitry 1501 that is operatively coupled to input/output interface 1505, radio frequency (RF) interface 1509, network connection interface 1511, memory 1515 including random access memory (RAM) 1517, read-only memory (ROM) 1519, and storage medium 1521 or the like, communication subsystem 1531, power source 1513, and/or any other component, or any combination thereof. Storage medium 1521 includes operating system 1523, application program 1525, and data 1527. In other embodiments, storage medium 1521 may include other similar types of information. Certain UEs may utilize all of the components shown in FIG. 19, or only a subset of the components. The level of integration between the components may vary from one UE to another UE. Further, certain UEs may contain multiple instances of a component, such as multiple processors, memories, transceivers, transmitters, receivers, etc.

In FIG. 19, processing circuitry 1501 may be configured to process computer instructions and data. Processing circuitry 1501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1501 may include two central processing units (CPUs). Data may be information in a form suitable for use by a computer.

In the depicted embodiment, input/output interface 1505 may be configured to provide a communication interface to an input device, output device, or input and output device. UE 1500 may be configured to use an output device via input/output interface 1505. An output device may use the same type of interface port as an input device. For example, a USB port may be used to provide input to and output from UE 1500. The output device may be a speaker, a sound card, a video card, a display, a monitor, a printer, an actuator, an emitter, a smartcard, another output device, or any combination thereof. UE 1500 may be configured to use an input device via input/output interface 1505 to allow a user to capture information into UE 1500. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 19, RF interface 1509 may be configured to provide a communication interface to RF components such as a transmitter, a receiver, and an antenna. Network connection interface 1511 may be configured to provide a communication interface to network 1543a. Network 1543a may encompass wired and/or wireless networks such as a local-area network (LAN), a wide-area network (WAN), a computer network, a wireless network, a telecommunications network, another like network or any combination thereof. For example, network 1543a may comprise a Wi-Fi network. Network connection interface 1511 may be configured to include a receiver and a transmitter interface used to communicate with one or more other devices over a communication network according to one or more communication protocols, such as Ethernet, TCP/IP, SONET, ATM, or the like. Network connection interface 1511 may implement receiver and transmitter functionality appropriate to the communication network links (e.g., optical, electrical, and the like). The transmitter and receiver functions may share circuit components, software or firmware, or alternatively may be implemented separately.

RAM 1517 may be configured to interface via bus 1502 to processing circuitry 1501 to provide storage or caching of data or computer instructions during the execution of software programs such as the operating system, application programs, and device drivers. ROM 1519 may be configured to provide computer instructions or data to processing circuitry 1501. For example, ROM 1519 may be configured to store invariant low-level system code or data for basic system functions such as basic input and output (I/O), startup, or reception of keystrokes from a keyboard that are stored in a non-volatile memory. Storage medium 1521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1521 may be configured to include operating system 1523, application program 1525 such as a web browser application, a widget or gadget engine or another application, and data file 1527. Storage medium 1521 may store, for use by UE 1500, any of a variety of various operating systems or combinations of operating systems.

Storage medium 1521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1521 may allow UE 1500 to access computer-executable instructions, application programs or the like, stored on transitory or non-transitory memory media, to off-load data, or to upload data. An article of manufacture, such as one utilizing a communication system may be tangibly embodied in storage medium 1521, which may comprise a device readable medium.

In FIG. 19, processing circuitry 1501 may be configured to communicate with network 1543b using communication subsystem 1531. Network 1543a and network 1543b may be the same network or networks or different network or networks. Communication subsystem 1531 may be configured to include one or more transceivers used to communicate with network 1543b. For example, communication subsystem 1531 may be configured to include one or more transceivers used to communicate with one or more remote transceivers of another device capable of wireless communication such as another wireless device, UE, or base station of a radio access network (RAN) according to one or more communication protocols, such as IEEE 802.15, CDMA, WCDMA, GSM, LTE, UTRAN, WiMax, or the like. Each transceiver may include transmitter 1533 and/or receiver 1535 to implement transmitter or receiver functionality, respectively, appropriate to the RAN links (e.g., frequency allocations and the like). Further, transmitter 1533 and receiver 1535 of each transceiver may share circuit components, software or firmware, or alternatively may be implemented separately.

In the illustrated embodiment, the communication functions of communication subsystem 1531 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1531 may include cellular communication, Wi-Fi communication, Bluetooth communication, and GPS communication. Network 1543b may encompass wired and/or wireless networks such as a local-area network (LAN), a wide-area network (WAN), a computer network, a wireless network, a telecommunications network, another like network or any combination thereof. For example, network 1543b may be a cellular network, a Wi-Fi network, and/or a near-field network. Power source 1513 may be configured to provide alternating current (AC) or direct current (DC) power to components of UE 1500.

The features, benefits and/or functions described herein may be implemented in one of the components of UE 1500 or partitioned across multiple components of UE 1500. Further, the features, benefits, and/or functions described herein may be implemented in any combination of hardware, software or firmware. In one example, communication subsystem 1531 may be configured to include any of the components described herein. Further, processing circuitry 1501 may be configured to communicate with any of such components over bus 1502. In another example, any of such components may be represented by program instructions stored in memory that when executed by processing circuitry 1501 perform the corresponding functions described herein. In another example, the functionality of any of such components may be partitioned between processing circuitry 1501 and communication subsystem 1531. In another example, the non-computationally intensive functions of any of such components may be implemented in software or firmware and the computationally intensive functions may be implemented in hardware.

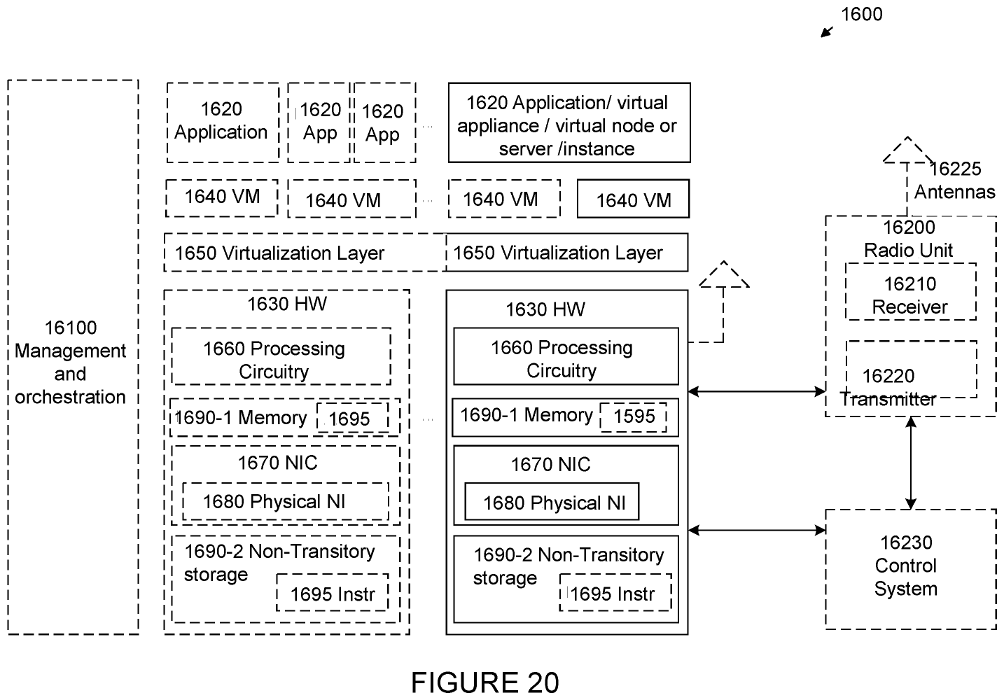

FIG. 20 is a schematic block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1600 hosted by one or more of hardware nodes 1630. Further, in embodiments in which the virtual node is not a radio access node or does not require radio connectivity (e.g., a core network node), then the network node may be entirely virtualized.

The functions may be implemented by one or more applications 1620 (which may alternatively be called software instances, virtual appliances, network functions, virtual nodes, virtual network functions, etc.) operative to implement some of the features, functions, and/or benefits of some of the embodiments disclosed herein. Applications 1620 are run in virtualization environment 1600 which provides hardware 1630 comprising processing circuitry 1660 and memory 1690. Memory 1690 contains instructions 1695 executable by processing circuitry 1660 whereby application 1620 is operative to provide one or more of the features, benefits, and/or functions disclosed herein.

Virtualization environment 1600, comprises general-purpose or special-purpose network hardware devices 1630 comprising a set of one or more processors or processing circuitry 1660, which may be commercial off-the-shelf (COTS) processors, dedicated Application Specific Integrated Circuits (ASICs), or any other type of processing circuitry including digital or analog hardware components or special purpose processors. Each hardware device may comprise memory 1690-1 which may be non-persistent memory for temporarily storing instructions 1695 or software executed by processing circuitry 1660. Each hardware device may comprise one or more network interface controllers (NICs) 1670, also known as network interface cards, which include physical network interface 1680. Each hardware device may also include non-transitory, persistent, machine-readable storage media 1690-2 having stored therein software 1695 and/or instructions executable by processing circuitry 1660. Software 1695 may include any type of software including software for instantiating one or more virtualization layers 1650 (also referred to as hypervisors), software to execute virtual machines 1640 as well as software allowing it to execute functions, features and/or benefits described in relation with some embodiments described herein.

Virtual machines 1640, comprise virtual processing, virtual memory, virtual networking or interface and virtual storage, and may be run by a corresponding virtualization layer 1650 or hypervisor. Different embodiments of the instance of virtual appliance 1620 may be implemented on one or more of virtual machines 1640, and the implementations may be made in different ways.

During operation, processing circuitry 1660 executes software 1695 to instantiate the hypervisor or virtualization layer 1650, which may sometimes be referred to as a virtual machine monitor (VMM). Virtualization layer 1650 may present a virtual operating platform that appears like networking hardware to virtual machine 1640.

As shown in FIG. 20, hardware 1630 may be a standalone network node with generic or specific components. Hardware 1630 may comprise antenna 16225 and may implement some functions via virtualization. Alternatively, hardware 1630 may be part of a larger cluster of hardware (e.g. such as in a data center or customer premise equipment (CPE)) where many hardware nodes work together and are managed via management and orchestration (MANO) 16100, which, among others, oversees lifecycle management of applications 1620.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1640 may be a software implementation of a physical machine that runs programs as if they were executing on a physical, non-virtualized machine. Each of virtual machines 1640, and that part of hardware 1630 that executes that virtual machine, be it hardware dedicated to that virtual machine and/or hardware shared by that virtual machine with others of the virtual machines 1640, forms a separate virtual network elements (VNE).

Still in the context of NFV, Virtual Network Function (VNF) is responsible for handling specific network functions that run in one or more virtual machines 1640 on top of hardware networking infrastructure 1630 and corresponds to application 1620 in FIG. 20.

In some embodiments, one or more radio units 16200 that each include one or more transmitters 16220 and one or more receivers 16210 may be coupled to one or more antennas 16225. Radio units 16200 may communicate directly with hardware nodes 1630 via one or more appropriate network interfaces and may be used in combination with the virtual components to provide a virtual node with radio capabilities, such as a radio access node or a base station.

In some embodiments, some signaling can be affected with the use of control system 16230 which may alternatively be used for communication between the hardware nodes 1630 and radio units 16200.

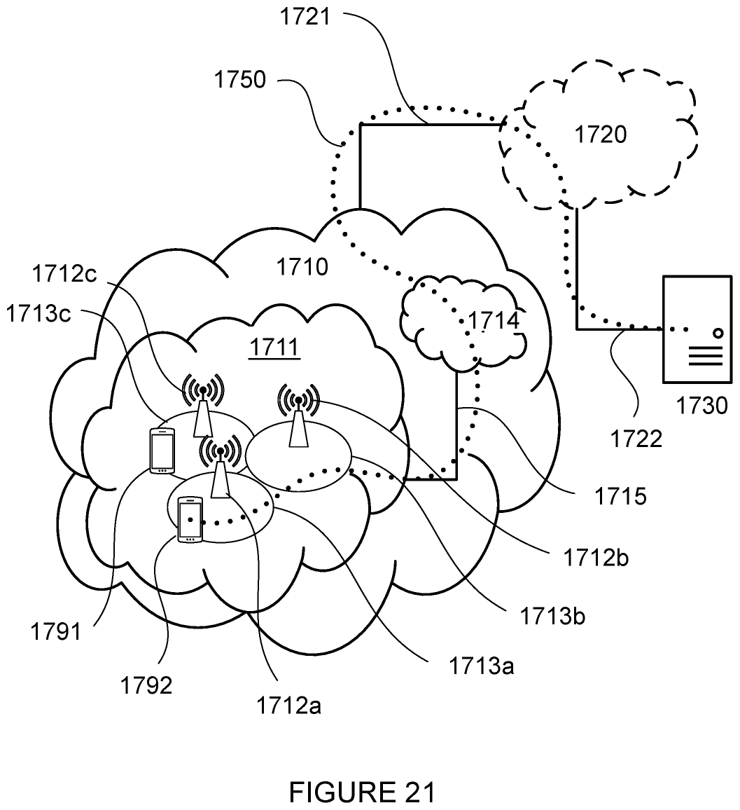

FIG. 21 illustrates a telecommunication network connected via an intermediate network to a host computer in accordance with some embodiments.

With reference to FIG. 21, in accordance with an embodiment, a communication system includes telecommunication network 1710, such as a 3GPP-type cellular network, which comprises access network 1711, such as a radio access network, and core network 1714. Access network 1711 comprises a plurality of base stations 1712a, 1712b, 1712c, such as NBs, eNBs, gNBs or other types of wireless access points, each defining a corresponding coverage area 1713a, 1713b, 1713c. Each base station 1712a, 1712b, 1712c is connectable to core network 1714 over a wired or wireless connection 1715. A first UE 1791 located in coverage area 1713c is configured to wirelessly connect to, or be paged by, the corresponding base station 1712c. A second UE 1792 in coverage area 1713a is wirelessly connectable to the corresponding base station 1712a. While a plurality of UEs 1791, 1792 are illustrated in this example, the disclosed embodiments are equally applicable to a situation where a sole UE is in the coverage area or where a sole UE is connecting to the corresponding base station 1712.

Telecommunication network 1710 is itself connected to host computer 1730, which may be embodied in the hardware and/or software of a standalone server, a cloud-implemented server, a distributed server or as processing resources in a server farm. Host computer 1730 may be under the ownership or control of a service provider or may be operated by the service provider or on behalf of the service provider. Connections 1721 and 1722 between telecommunication network 1710 and host computer 1730 may extend directly from core network 1714 to host computer 1730 or may go via an optional intermediate network 1720. Intermediate network 1720 may be one of, or a combination of more than one of, a public, private or hosted network; intermediate network 1720, if any, may be a backbone network or the Internet; in particular, intermediate network 1720 may comprise two or more sub-networks (not shown).

The communication system of FIG. 21 as a whole enables connectivity between the connected UEs 1791, 1792 and host computer 1730. The connectivity may be described as an over-the-top (OTT) connection 1750. Host computer 1730 and the connected UEs 1791, 1792 are configured to communicate data and/or signaling via OTT connection 1750, using access network 1711, core network 1714, any intermediate network 1720 and possible further infrastructure (not shown) as intermediaries. OTT connection 1750 may be transparent in the sense that the participating communication devices through which OTT connection 1750 passes are unaware of routing of uplink and downlink communications. For example, base station 1712 may not or need not be informed about the past routing of an incoming downlink communication with data originating from host computer 1730 to be forwarded (e.g., handed over) to a connected UE 1791. Similarly, base station 1712 need not be aware of the future routing of an outgoing uplink communication originating from the UE 1791 towards the host computer 1730.

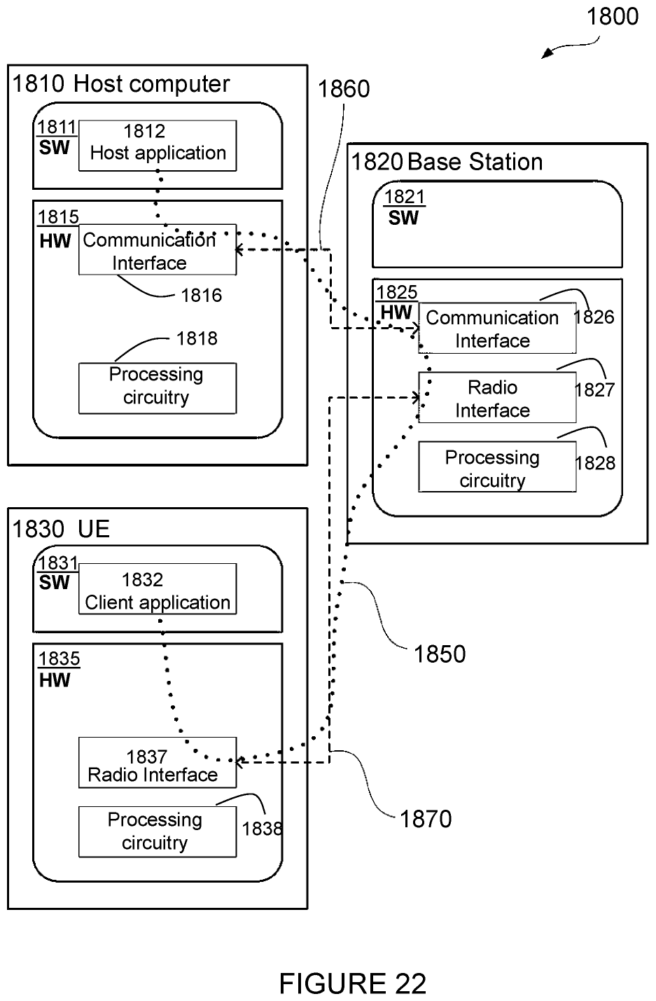

FIG. 22 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 22. In communication system 1800, host computer 1810 comprises hardware 1815 including communication interface 1816 configured to set up and maintain a wired or wireless connection with an interface of a different communication device of communication system 1800. Host computer 1810 further comprises processing circuitry 1818, which may have storage and/or processing capabilities. In particular, processing circuitry 1818 may comprise one or more programmable processors, application-specific integrated circuits, field programmable gate arrays or combinations of these (not shown) adapted to execute instructions. Host computer 1810 further comprises software 1811, which is stored in or accessible by host computer 1810 and executable by processing circuitry 1818. Software 1811 includes host application 1812. Host application 1812 may be operable to provide a service to a remote user, such as UE 1830 connecting via OTT connection 1850 terminating at UE 1830 and host computer 1810. In providing the service to the remote user, host application 1812 may provide user data which is transmitted using OTT connection 1850.

Communication system 1800 further includes base station 1820 provided in a telecommunication system and comprising hardware 1825 enabling it to communicate with host computer 1810 and with UE 1830. Hardware 1825 may include communication interface 1826 for setting up and maintaining a wired or wireless connection with an interface of a different communication device of communication system 1800, as well as radio interface 1827 for setting up and maintaining at least wireless connection 1870 with UE 1830 located in a coverage area (not shown in FIG. 22) served by base station 1820. Communication interface 1826 may be configured to facilitate connection 1860 to host computer 1810. Connection 1860 may be direct or it may pass through a core network (not shown in FIG. 22) of the telecommunication system and/or through one or more intermediate networks outside the telecommunication system. In the embodiment shown, hardware 1825 of base station 1820 further includes processing circuitry 1828, which may comprise one or more programmable processors, application-specific integrated circuits, field programmable gate arrays or combinations of these (not shown) adapted to execute instructions. Base station 1820 further has software 1821 stored internally or accessible via an external connection.

Communication system 1800 further includes UE 1830 already referred to. Its hardware 1835 may include radio interface 1837 configured to set up and maintain wireless connection 1870 with a base station serving a coverage area in which UE 1830 is currently located. Hardware 1835 of UE 1830 further includes processing circuitry 1838, which may comprise one or more programmable processors, application-specific integrated circuits, field programmable gate arrays or combinations of these (not shown) adapted to execute instructions. UE 1830 further comprises software 1831, which is stored in or accessible by UE 1830 and executable by processing circuitry 1838. Software 1831 includes client application 1832. Client application 1832 may be operable to provide a service to a human or non-human user via UE 1830, with the support of host computer 1810. In host computer 1810, an executing host application 1812 may communicate with the executing client application 1832 via OTT connection 1850 terminating at UE 1830 and host computer 1810. In providing the service to the user, client application 1832 may receive request data from host application 1812 and provide user data in response to the request data. OTT connection 1850 may transfer both the request data and the user data. Client application 1832 may interact with the user to generate the user data that it provides.

It is noted that host computer 1810, base station 1820 and UE 1830 illustrated in FIG. 22 may be similar or identical to host computer 1730, one of base stations 1712a, 1712b, 1712c and one of UEs 1791, 1792 of FIG. 21, respectively. This is to say, the inner workings of these entities may be as shown in FIG. 22 and independently, the surrounding network topology may be that of FIG. 21.

In FIG. 22, OTT connection 1850 has been drawn abstractly to illustrate the communication between host computer 1810 and UE 1830 via base station 1820, without explicit reference to any intermediary devices and the precise routing of messages via these devices. Network infrastructure may determine the routing, which it may be configured to hide from UE 1830 or from the service provider operating host computer 1810, or both. While OTT connection 1850 is active, the network infrastructure may further take decisions by which it dynamically changes the routing (e.g., on the basis of load balancing consideration or reconfiguration of the network).

Wireless connection 1870 between UE 1830 and base station 1820 is in accordance with the teachings of the embodiments described throughout this disclosure. One or more of the various embodiments improve the performance of OTT services provided to UE 1830 using OTT connection 1850, in which wireless connection 1870 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 1850 between host computer 1810 and UE 1830, in response to variations in the measurement results. The measurement procedure and/or the network functionality for reconfiguring OTT connection 1850 may be implemented in software 1811 and hardware 1815 of host computer 1810 or in software 1831 and hardware 1835 of UE 1830, or both. In embodiments, sensors (not shown) may be deployed in or in association with communication devices through which OTT connection 1850 passes; the sensors may participate in the measurement procedure by supplying values of the monitored quantities exemplified above or supplying values of other physical quantities from which software 1811, 1831 may compute or estimate the monitored quantities. The reconfiguring of OTT connection 1850 may include message format, retransmission settings, preferred routing etc.; the reconfiguring need not affect base station 1820, and it may be unknown or imperceptible to base station 1820. Such procedures and functionalities may be known and practiced in the art. In certain embodiments, measurements may involve proprietary UE signaling facilitating host computer 1810's measurements of throughput, propagation times, latency and the like. The measurements may be implemented in that software 1811 and 1831 causes messages to be transmitted, in particular empty or ‘dummy’ messages, using OTT connection 1850 while it monitors propagation times, errors etc.

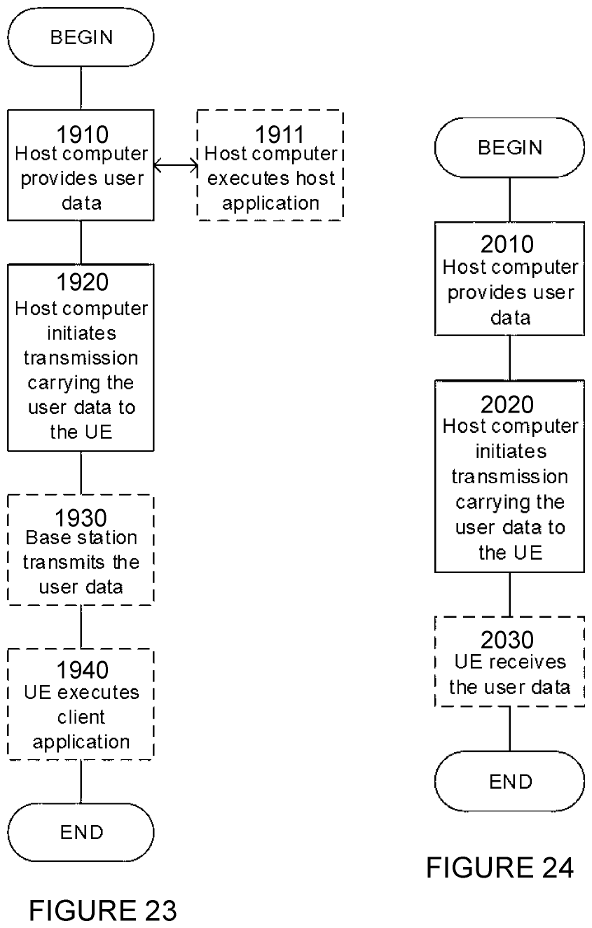

FIG. 23 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 23 will be included in this section. In step 1910, the host computer provides user data. In substep 1911 (which may be optional) of step 1910, the host computer provides the user data by executing a host application. In step 1920, the host computer initiates a transmission carrying the user data to the UE. In step 1930 (which may be optional), the base station transmits to the UE the user data which was carried in the transmission that the host computer initiated, in accordance with the teachings of the embodiments described throughout this disclosure. In step 1940 (which may also be optional), the UE executes a client application associated with the host application executed by the host computer.

FIG. 24 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 16 will be included in this section. In step 2010 of the method, the host computer provides user data. In an optional substep (not shown) the host computer provides the user data by executing a host application. In step 2020, the host computer initiates a transmission carrying the user data to the UE. The transmission may pass via the base station, in accordance with the teachings of the embodiments described throughout this disclosure. In step 2030 (which may be optional), the UE receives the user data carried in the transmission.

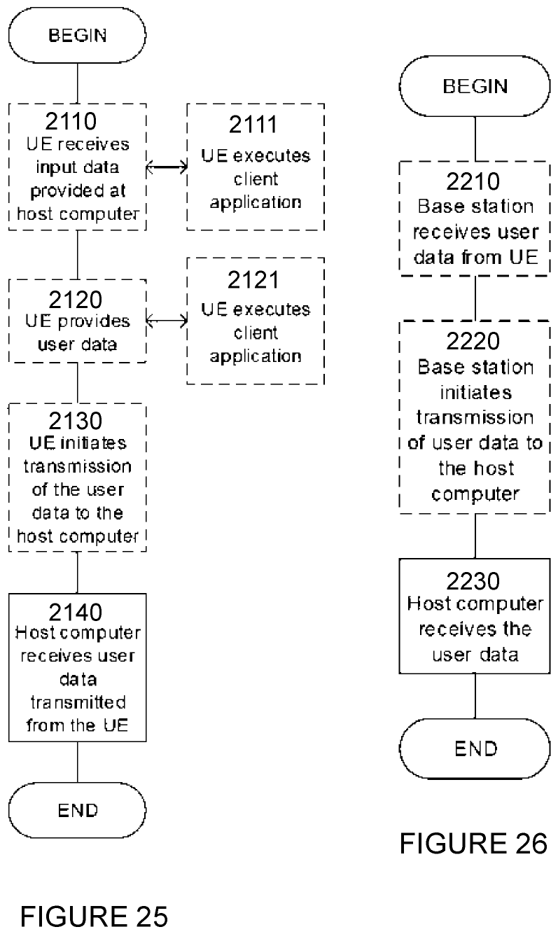

FIG. 25 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 25 will be included in this section. In step 2110 (which may be optional), the UE receives input data provided by the host computer. Additionally or alternatively, in step 2120, the UE provides user data. In substep 2121 (which may be optional) of step 2120, the UE provides the user data by executing a client application. In substep 2111 (which may be optional) of step 2110, the UE executes a client application which provides the user data in reaction to the received input data provided by the host computer. In providing the user data, the executed client application may further consider user input received from the user. Regardless of the specific manner in which the user data was provided, the UE initiates, in substep 2130 (which may be optional), transmission of the user data to the host computer. In step 2140 of the method, the host computer receives the user data transmitted from the UE, in accordance with the teachings of the embodiments described throughout this disclosure.

FIG. 26 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 26 will be included in this section. In step 2210 (which may be optional), in accordance with the teachings of the embodiments described throughout this disclosure, the base station receives user data from the UE. In step 2220 (which may be optional), the base station initiates transmission of the received user data to the host computer. In step 2230 (which may be optional), the host computer receives the user data carried in the transmission initiated by the base station.

### Example Embodiments

### Group A Example Embodiments

Example A1. A method by a wireless device comprising: determining an action to perform, the action associated with an airborne or spaceborne system; selecting data associated with the airborne or spaceborne system; and performing the action based on the data associated with the airborne or spaceborne system.

Example A2. The method of Example Embodiments A1, further comprising determining the airborne or spaceborne system that is associated with the action.

Example A3a. The method of any one of Example Embodiments A1 to A2, further wherein the action comprises an action associated with at least one cell.

Example A3b. The method of Example Embodiment A3a, wherein the at least one cell comprises at least one cell that neighbors a serving cell in which the wireless device is currently served.

Example A3c. The method of Example Embodiment A3b, wherein the at least one cell that neighbors the serving cell comprises an edge cell, and wherein the data further comprises data associated at least one additional neighboring cell.

Example A3d. The method of Embodiment A3b, wherein the at least one cell that neighbors the serving cell comprises a corner cell, and wherein the data further comprises data associated at least two additional neighboring cells.

Example A3e. The method of any one of Example Embodiments A3a to A3d, wherein the at least one cell comprises at least one serving cell in which the wireless device is served, and the data comprises data associated with the at least one serving cell.

Example A4a. The method of any one of Example Embodiments A3a to A3c, wherein the action may include at least one of: performing a Radio Resource Management (RRM) measurement for the at least one cell; replacing a RRM measurement for the at least one cell; performing a user equipment (UE) mobility handover to the at least one cell; and performing a service link handover to the at least one cell.

Example A4b. The method of Example Embodiment A4a, wherein the action comprises the service link handover and the data comprises ephemeris data associated with a satellite in a serving cell, the satellite providing coverage in the serving cell at a future time.

Example A4c. The method of Example Embodiment A4a, wherein the action comprises the UE mobility handover and/or a RRM measurement and the data comprises ephemeris data associated with a satellite in a cell that neighbors a serving cell in which the wireless device is currently served.

Example A5. The method of any one of Example Embodiments A3a to A4c, further comprising determining the at least one cell to be used in the action associated with the airborne or spaceborne system.

Example A6. The method of any one of Example Embodiments A1 to A5, further comprising determining that the data associated with the airborne or spaceborne system is valid.

Example A1a. The method of Example Embodiment A6, further comprising receiving system information (SI) from the network node, and wherein the data is determined to be valid based on the SI.

Example A7b. The method of Example Embodiment A6, wherein determining that the data associated with the airborne or spaceborne system is valid comprises: determining that at least a portion of the data associated with the airborne or spaceborne system is expired; and updating the portion of the data that is expired.

Example A7c. The method of Example Embodiment A7b, wherein determining that the portion of the data is expired comprises determining that a timer associated with the data has expired.

Example A8. The method of any one of Example Embodiments A7b to A7c, wherein updating the portion of the data comprises: determining at least one system information block (SIB) associated with the data; determining a resource allocation associated with the SIB; receiving the SIB associated with the data; and decoding the SIB associated with the data.

Example A9. The method of Example Embodiment A6, wherein determining that the data associated with the airborne or spaceborne system is valid comprises: determining when the action will be complete; determining that at least a portion of the data associated with the action will expire before the action is complete; and updating the portion of the data that will expire before the action is complete.

Example A10a. The method of Example Embodiment A6, wherein determining that the data associated with the airborne or spaceborne system is valid comprises: decoding a signal from a network node; and determining, based on the signal from the network node, that the data associated with the airborne or spaceborne system is valid.

Example A10b. The method of Example Embodiment A10a, wherein the signal comprises system information (SI).

Example A10c. The method of Example Embodiment A10a, wherein the signal comprises a SIB1.

Example A10d. The method of Example Embodiment A10a, wherein the signal comprises downlink control information (DCI).

Example A10e. The method of Example Embodiment A10a, wherein the signal comprises a short message code point.

Example A11. The method of Example Embodiments A6, wherein determining that the data associated with the action is valid comprises: decoding a signal from a network node; and determining, based on the signal from the network node, that the data associated with the airborne or spaceborne system needs to be updated; and updating the data associated with the airborne or spaceborne system.

Example A12. The method of Example Embodiment A6, wherein determining that the data associated with the airborne or spaceborne system is valid comprises determining that a timer associated with the data has not expired.

Example A13a. The method of any one of Example Embodiments A1 to A12, wherein the data associated with the airborne or spaceborne system comprises at least one of: a cell identifier; a satellite identifier; carrier information and/or Bandwidth part (BWP) of the neighboring cell; satellite ephemeris data; time interval of cell coverage; cell reference location; and Koffset.

Example A13b. The method of any one of Example Embodiments A1 to A13a, wherein the data associated with the airborne or spaceborne system comprises at least one of semi-stationary data that changes according to a first periodicity, coarse data that changes according to a second periodicity, and fine data that changes according third periodicity, and wherein: the first periodicity is greater than the second periodicity and the third periodicity, and the second periodicity is greater than the third periodicity.

Example A13c. The method of Example Embodiment A13b, wherein the semi-stationary data, the coarse data, and the fine data are received in separate transmissions.

Example A13d. The method of any one of Example Embodiments A13b to A13c, wherein the fine data comprises a satellite index.

Example A13e. The method of any one of Example Embodiment A13b to A13d, wherein the coarse data comprises at least one of: a satellite index, and short term ephemeris data.

Example A13f. The method of any one of Example Embodiments A13b to A13e, wherein the semi-stationary data comprises at least one of: an orbit index, and long term ephemeris data.

Example A13g. The method of any one of Example Embodiments A13c to A13f, wherein a transmission of the fine data comprises a reference a SIB containing the coarse data.

Example A14a. The method of any one of Example Embodiments A1 to A13g, further comprising receiving the data associated with the airborne or spaceborne system from the network node.

Example A14b. The method of Example Embodiment A14a, wherein the data comprises ephemeris data received as system information (SI).

Example A14c. The method of Example Embodiment A14b, further comprising: prior to receiving the SI, receiving a signal from the network node, the signal indicating at least one transmission resource for receiving the SI.

Example A14d. The method of Example Embodiment A14c, wherein the signal comprises a SIB1 or a downlink control information (DCI) message.

Example A14e. The method of any one of Example Embodiments A14c to A14d, wherein the at least one transmission resource comprises at least one a transmission time, a transmission frequency, and/or a periodicity.

Example A14f. The method of any one of Example Embodiments A14a to A14e, wherein the data is periodically received.

Example A15a. The method of any one of Example Embodiments A1 to A14f, wherein the airborne or spaceborne system comprises at least one satellite.

Example A15b. The method of Example Embodiment A15a, wherein the at least one satellite comprises a satellite associated with a cell that neighbors a serving cell in which the wireless device is served.

Example A15c. The method of any one of Example Embodiments A15a to A15b, wherein the at least one satellite comprises a satellite associated with a serving cell, the satellite providing future coverage of the serving cell for the wireless device.

Example A16. The method of any one of Example Embodiments A1 to A15, wherein the airborne or spaceborne system comprises a High Altitude Platform System (HAPS) or a HAPS as IMT Base Station (HIBS).

Example A17. The method of any one of Example Embodiments A1 to A16, wherein the data associated with the airborne or spaceborne system comprises at least two portions of data, each portion of data being associated with a measure of longevity, each measure of longevity comprising a measure of how long each portion of data will be valid and/or require an update.

Example A18. The method of any one of Example Embodiments A1 to A17, the data is associated with at least one coverage type.

Example A19. The method of Example Embodiment A18, wherein the at least one coverage type comprises at least one of: a current neighboring cell coverage, a future serving cell coverage; and a future neighboring cell coverage.

Example A20. The method of any one of Example Embodiments A18 to A19, wherein each type of the at least one coverage type is associated with a SIB index, a SIB periodicity, and/or a ephemeris content.

Example A21. The method of any one of Example Embodiments A18 to A20, wherein each type of the at least one coverage type is associated with a particular one of a plurality of satellites.

Example A22. The method of any one of Example Embodiments A18 to A21, wherein the at least one coverage type is associated with a satellite index.

Example A23. The method of any one of Example Embodiments A18 to A22, wherein the at least one coverage type is associated with an ephemeris validity duration.

Example A24. A wireless device comprising processing circuitry configured to perform any of the methods of Example Embodiments A1 to A23.

Example A25. A computer program comprising instructions which when executed on a computer perform any of the methods of Example Embodiments A1 to A23.

Example A26. A computer program product comprising computer program, the computer program comprising instructions which when executed on a computer perform any of the methods of Example Embodiments A1 to A23.

Example A27. A non-transitory computer readable medium storing instructions which when executed by a computer perform any of the methods of Example Embodiments A1 to A23.

### Group B Embodiments

Example B1. A method by a network node comprising: determining an action to be performed by the wireless device; determining at least one an airborne or spaceborne system associated with the action be performed by the wireless device; determining data associated with the at least one an airborne or spaceborne system that is associated with the action to be performed by the wireless device; and transmitting the data associated with the airborne or spaceborne system to the wireless device.

Example B2. The method of Example Embodiment B1, further comprising determining at least one cell associated with the action to be performed by the wireless device.

Example B3a. The method of Example Embodiment B2, wherein the at least one cell comprises at least one cell that neighbors a serving cell in which the wireless device is currently served.

Example B3b. The method of Example Embodiment B3a, wherein the at least one cell that neighbors the serving cell comprises an edge cell, and wherein the data further comprises data associated at least one additional neighboring cell.

Example B3c. The method of Embodiment B3a, wherein the at least one cell that neighbors the serving cell comprises a corner cell, and wherein the data further comprises data associated at least two additional neighboring cells.

Example B4. The method of any one of Example Embodiments B2 to B3c, wherein the at least one cell comprises a serving cell in which the wireless device is served, and the data comprises data associated with the at least one serving cell.

Example B5a. The method of any one of Example Embodiments B2 to B4, wherein the action to be performed by the wireless device comprises at least one of: performing a Radio Resource Management (RRM) measurement for the at least one cell; replacing a RRM measurement for the at least one cell; performing a user equipment (UE) mobility handover to the at least one cell; and performing a service link handover to the at least one cell.

Example B5b. The method of Example Embodiment B5a, wherein the action comprises the service link handover and the data comprises ephemeris data associated with a satellite in a serving cell, the satellite providing coverage in the serving cell at a future time.

Example B5c. The method of Example Embodiment B5a, wherein the action comprises the UE mobility handover and/or a RRM measurement and the data comprises ephemeris data associated with a satellite in a cell that neighbors a serving cell in which the wireless device is currently served.

Example B6. The method of any one of Example Embodiments B2 to B5c, further comprising determining the at least one cell is associated with the airborne or spaceborne system.

Example B7. The method of any one of Example Embodiments B1 to B6, further comprising: determining that at least a portion of the data associated with the airborne or spaceborne system is expired or will expire; determining updated data for the portion of the data that is expired or will expire; and transmitting the updated data to the wireless device.

Example B8. The method of Example Embodiment B7, wherein determining that the portion of the data is expired or will expire comprises determining that a timer associated with the data has expired or will expire.

Example B9. The method of Example Embodiment B7, wherein the updated data is transmitted in at least one system information block (SIB).

Example 310a. The method of any one of Example Embodiments B7 to B9, further comprising transmitting a signal to the wireless device, the signal indicating that the data has been updated.

Example 310b. The method of Example Embodiment 310a, wherein the signal comprises downlink control information (DCI) indicating that the data has been updated.

Example 310c. The method of Example Embodiment 310a, wherein the signal comprises a short message code point.

Example 310d. The method of Example Embodiment 310a, wherein the signal comprises a SIB1.

Example B11a. The method of any one of Example Embodiments B1 to 310, wherein the data associated with the airborne or spaceborne system comprises at least one of: a cell identifier; a satellite identifier; carrier information and/or Bandwidth part (BWP) of the neighboring cell; satellite ephemeris data; time interval of cell coverage; cell reference location; and Koffset.

Example B11b. The method of any one of Example Embodiments B1 to B11a, wherein the data associated with the airborne or spaceborne system comprises at least one of semi-stationary data that changes according to a first periodicity, coarse data that changes according to a second periodicity, and fine data that changes according third periodicity, and wherein: the first periodicity is greater than the second periodicity and the third periodicity, and the second periodicity is greater than the third periodicity.

Example B11c. The method of Example Embodiment B11b, wherein transmitting the data comprises transmitting the semi-stationary data, the coarse data, and the fine data in separate transmissions.

Example B11d. The method of any one of Example Embodiments B11 b to B11c, wherein the fine data comprises a satellite index.

Example B11e. The method of any one of Example Embodiment B11b to B11d, wherein the coarse data comprises at least one of: a satellite index, and short term ephemeris data.

Example B11f. The method of any one of Example Embodiments B11b to B11e, wherein the semi-stationary data comprises at least one of: an orbit index, and long term ephemeris data.

Example B11g. The method of any one of Example Embodiments B11c to B11f, wherein a transmission of the fine data comprises a reference a SIB containing the coarse data.

Example B12a. The method of any one of Example Embodiments B1 to B11g, wherein the airborne or spaceborne system comprises at least one satellite.

Example B12b. The method of Example Embodiment B12a, wherein the at least one satellite comprises a satellite associated with a cell that neighbors a serving cell in which the wireless device is served.

Example B12c. The method of any one of Example Embodiments B12a to B12b, wherein the at least one satellite comprises a satellite associated with a serving cell, the satellite providing future coverage of the serving cell for the wireless device.

Example B13. The method of any one of Example Embodiments B1 to B12c, wherein the airborne or spaceborne system comprises a High Altitude Platform System (HAPS) or a HAPS as IMT Base Station (HIBS).

Example B14. The method of any one of Example Embodiments B1 to B13, further comprising separating the data associated with the airborne or spaceborne system into at least two portions of data, each portion of data being associated with a measure of longevity, each measure of longevity comprising a measure of how long each portion of data will be valid and/or require an update.

Example B15. The method of any one of Example Embodiments B1 to B14, wherein transmitting the data comprises transmitting the data via system information (SI).

Example B16. The method of Example Embodiment B15, further comprising: prior to transmitting the SI, transmitting a signal to the wireless device, the signal indicating at least one transmission resource for receiving the SI by the wireless device.

Example B17. The method of Example Embodiment B16, wherein the at least one transmission resource comprises at least one a transmission time, a transmission frequency, and/or a periodicity.

Example B18. The method of any one of Example Embodiments B16 to B17, wherein the signal comprises a SIB1 or a downlink control information (DCI) message.

Example B19. The method of any one of Example Embodiments B1 to B18, wherein transmitting the data comprises periodically transmitting the data to the wireless device.

Example B20. The method of any one of Example Embodiments B1 to B19, further comprising: prior to determining the at least one an airborne or spaceborne system associated with the action be performed by the wireless device, determining at least one coverage type for which the data is to be provided.

Example B21. The method of Example Embodiment B20, wherein the at least one coverage type comprises at least one of: a current neighboring cell coverage, a future serving cell coverage; and a future neighboring cell coverage.

Example B22. The method of any one of Example Embodiments B20 to B21, wherein each type of the at least one coverage type is associated with a SIB index, a SIB periodicity, and/or a ephemeris content.

Example B23. The method of any one of Example Embodiments B20 to B22, wherein each type of the at least one coverage type is associated with a particular one of a plurality of satellites.

Example B24. The method of any one of Example Embodiments B20 to B23, wherein the at least one coverage type is associated with a satellite index.

Example B25. The method of any one of Example Embodiments B20 to B24, wherein the at least one coverage type is associated with an ephemeris validity duration.

Example B26. A network node comprising processing circuitry configured to perform any of the methods of Example Embodiments B1 to B25.

Example B27. A computer program comprising instructions which when executed on a computer perform any of the methods of Example Embodiments B1 to B25.

Example B28. A computer program product comprising computer program, the computer program comprising instructions which when executed on a computer perform any of the methods of Example Embodiments B1 to B25.

Example B29. A non-transitory computer readable medium storing instructions which when executed by a computer perform any of the methods of Example Embodiments B1 to B25.

### Group C Example Embodiments

Example C1. A wireless device comprising: processing circuitry configured to perform any of the steps of any of the Group A Example Embodiments; and power supply circuitry configured to supply power to the wireless device.

Example C2. A network node comprising: processing circuitry configured to perform any of the steps of any of the Group B Example Embodiments; power supply circuitry configured to supply power to the wireless device.

Example C3. A wireless device, the wireless device comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A Example Embodiments; an input interface connected to the processing circuitry and configured to allow input of information into the wireless device to be processed by the processing circuitry; an output interface connected to the processing circuitry and configured to output information from the wireless device that has been processed by the processing circuitry; and a battery connected to the processing circuitry and configured to supply power to the wireless device.

Example C4. A communication system including a host computer comprising: processing circuitry configured to provide user data; and a communication interface configured to forward the user data to a cellular network for transmission to a wireless device, wherein the cellular network comprises a network node having a radio interface and processing circuitry, the network node's processing circuitry configured to perform any of the steps of any of the Group B Example Embodiments.

Example C5. The communication system of the pervious embodiment further including the network node.

Example C6. The communication system of the previous 2 embodiments, further including the wireless device, wherein the wireless device is configured to communicate with the network node.

Example C7. The communication system of the previous 3 embodiments, wherein: the processing circuitry of the host computer is configured to execute a host application, thereby providing the user data; and the wireless device comprises processing circuitry configured to execute a client application associated with the host application.

Example C8. A method implemented in a communication system including a host computer, a network node and a wireless device, the method comprising: at the host computer, providing user data; and at the host computer, initiating a transmission carrying the user data to the wireless device via a cellular network comprising the network node, wherein the network node performs any of the steps of any of the Group B Example Embodiments.

Example C9. The method of the previous embodiment, further comprising, at the network node, transmitting the user data.

Example C10. The method of the previous 2 embodiments, wherein the user data is provided at the host computer by executing a host application, the method further comprising, at the wireless device, executing a client application associated with the host application.

Example C11. A wireless device configured to communicate with a network node, the wireless device comprising a radio interface and processing circuitry configured to perform any of the methods of the previous 3 embodiments.

Example C12. A communication system including a host computer comprising: processing circuitry configured to provide user data; and a communication interface configured to forward user data to a cellular network for transmission to a wireless device, wherein the wireless device comprises a radio interface and processing circuitry, the wireless device's components configured to perform any of the steps of any of the Group A Example Embodiments.

Example C13. The communication system of the previous embodiment, wherein the cellular network further includes a network node configured to communicate with the wireless device.

Example C14. The communication system of the previous 2 embodiments, wherein: the processing circuitry of the host computer is configured to execute a host application, thereby providing the user data; and the wireless device's processing circuitry is configured to execute a client application associated with the host application.

Example C15. A method implemented in a communication system including a host computer, a network node and a wireless device, the method comprising: at the host computer, providing user data; and at the host computer, initiating a transmission carrying the user data to the wireless device via a cellular network comprising the network node, wherein the wireless device performs any of the steps of any of the Group A Example Embodiments.

Example C16. The method of the previous embodiment, further comprising at the wireless device, receiving the user data from the network node.

Example C17. A communication system including a host computer comprising: communication interface configured to receive user data originating from a transmission from a wireless device to a network node, wherein the wireless device comprises a radio interface and processing circuitry, the wireless device's processing circuitry configured to perform any of the steps of any of the Group A Example Embodiments.

Example C18. The communication system of the previous embodiment, further including the wireless device.

Example C19. The communication system of the previous 2 embodiments, further including the network node, wherein the network node comprises a radio interface configured to communicate with the wireless device and a communication interface configured to forward to the host computer the user data carried by a transmission from the wireless device to the network node.

Example C20. The communication system of the previous 3 embodiments, wherein: the processing circuitry of the host computer is configured to execute a host application; and the wireless device's processing circuitry is configured to execute a client application associated with the host application, thereby providing the user data.

Example C21. The communication system of the previous 4 embodiments, wherein: the processing circuitry of the host computer is configured to execute a host application, thereby providing request data; and the wireless device's processing circuitry is configured to execute a client application associated with the host application, thereby providing the user data in response to the request data.

Example C22. A method implemented in a communication system including a host computer, a network node and a wireless device, the method comprising: at the host computer, receiving user data transmitted to the network node from the wireless device, wherein the wireless device performs any of the steps of any of the Group A Example Embodiments.

Example C23. The method of the previous embodiment, further comprising, at the wireless device, providing the user data to the network node.

Example C24. The method of the previous 2 embodiments, further comprising: at the wireless device, executing a client application, thereby providing the user data to be transmitted; and at the host computer, executing a host application associated with the client application.

Example C25. The method of the previous 3 embodiments, further comprising: at the wireless device, executing a client application; and at the wireless device, receiving input data to the client application, the input data being provided at the host computer by executing a host application associated with the client application, wherein the user data to be transmitted is provided by the client application in response to the input data.

Example C26. A communication system including a host computer comprising a communication interface configured to receive user data originating from a transmission from a wireless device to a network node, wherein the network node comprises a radio interface and processing circuitry, the network node's processing circuitry configured to perform any of the steps of any of the Group B Example Embodiments.

Example C27. The communication system of the previous embodiment further including the network node.

Example C28. The communication system of the previous 2 embodiments, further including the wireless device, wherein the wireless device is configured to communicate with the network node.

Example C29. The communication system of the previous 3 embodiments, wherein: the processing circuitry of the host computer is configured to execute a host application; the wireless device is configured to execute a client application associated with the host application, thereby providing the user data to be received by the host computer.

Example C30. A method implemented in a communication system including a host computer, a network node and a wireless device, the method comprising: at the host computer, receiving, from the base station, user data originating from a transmission which the network node has received from the wireless device, wherein the wireless device performs any of the steps of any of the Group A Example Embodiments.

Example C31. The method of the previous embodiment, further comprising at the network node receiving the user data from the wireless device.

Example C32. The method of the previous 2 embodiments, further comprising at the network node, initiating a transmission of the received user data to the host computer.

Example C33. The method of any of the previous embodiments, wherein the network node comprises a base station.

Example C34. The method of any of the previous embodiments, wherein the wireless device comprises a user equipment (UE).

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1. A method performed by a wireless device comprising:
receiving, from a network node, data associated with the airborne or spaceborne system, the data comprising satellite ephemeris data and a validity duration for the ephemeris data.

2. The method of claim 1, further comprising:
performing an action based on the data associated with the airborne or spaceborne system.

3. The method of claim 2, wherein the action is associated with at least one cell.

4. The method of claim 2, further comprising:
determining when the action will be complete;
determining that at least a portion of the data will expire before the action is complete; and
updating the portion of the data that will expire before the action is complete.

5. The method of claim 2, wherein the at least one cell comprises a serving cell in which the wireless device is currently served.

6. The method of claim 2, wherein
the at least one cell comprises at least one cell that neighbors the serving cell in which the wireless device is currently served.

7. The method of claim 6, wherein performing the at least one action comprises performing a measurement associated with the at least one cell that neighbors the serving cell before coverage in the serving cell ceases.

8. The method of claim 6, wherein the airborne or spaceborne system comprises at least one satellite associated with the serving cell or the at least one cell that neighbors the serving cell.

9. The method of claim 2, wherein the action comprises a service link handover and the ephemeris data is associated with a satellite providing coverage in the serving cell at a future time.

10. The method of claim 2, wherein the action comprises a UE mobility handover and/or a RRM measurement and the ephemeris data is associated with a satellite in a cell that neighbors the serving cell in which the wireless device is currently served.

11. The method of claim 1, further comprising determining whether the data associated with the airborne or spaceborne system is valid based on information received from the network node or based on whether a timer associated with the data has expired.

12. The method of claim 11, wherein the information received from the network node comprises system information (SI), downlink control information (DCI), or short message code point.

13. The method of claim 1, wherein, upon determining that at least a portion of the data associated with the airborne or spaceborne system is expired or is about to expire, the method further comprises updating the portion of the data that is expired or is about to expire.

14. The method of claim 1, wherein the data associated with the airborne or spaceborne system further comprises at least one of:
a cell identifier;
a satellite identifier;
carrier information and/or Bandwidth part (BWP) of a neighboring cell;
time interval of cell coverage;
cell reference location; and
Koffset.

15. The method of claim 1, wherein the data associated with the airborne or spaceborne system comprises at least one of semi-stationary data that changes according to a first periodicity, coarse data that changes according to a second periodicity, and fine data that changes according to a third periodicity, and wherein:
the first periodicity is greater than the second periodicity and the third periodicity, and
the second periodicity is greater than the third periodicity.

16. The method of claim 15, wherein:
the coarse data comprises at least one of: a satellite index, and short term ephemeris data, and
the semi-stationary data comprises at least one of: an orbit index, and long term ephemeris data.

17. The method of claim 1, wherein the data is associated with at least one coverage time interval, and wherein the at least one coverage time interval comprises at least one of: a current neighboring cell coverage time interval, a future serving cell coverage time interval; and a future neighboring cell coverage time interval.

18. The method of claim 17, wherein the at least one coverage time interval is associated with a SIB index, a SIB periodicity, a ephemeris content, and/or a satellite index.

19. A method performed by a network node comprising:
transmitting data associated with an airborne or spaceborne system to a wireless device, the data comprising satellite ephemeris data and a validity duration for the ephemeris data.

20. The method of claim 19, further comprising determining an action to be performed by the wireless device based on the data associated with the airborne or spaceborne system.

21. The method of claim 20, wherein the action is associated with at least one cell.

22. The method of claim 21, wherein the at least one cell comprises a serving cell in which the wireless device is currently served.

23. The method of claim 21, wherein the at least one cell comprises at least one cell that neighbors the serving cell in which the wireless device is currently served.

24. The method of claim 22, wherein the airborne or spaceborne system comprises at least one satellite associated with the serving cell or the at least one cell that neighbors the serving cell.

25.-38. (canceled)

39. A wireless device adapted to perform any of the methods of claim 1.

40. A network node adapted to perform any of the methods of claim 19.
